(19) United States
(12) Patent Application Publication
(10) Pub. No.: US 2002/0170360 A1
(43) Pub. Date: Nov. 21, 2002

(54) Apparatus for characterizing material properties and method

(76) Inventors: Lallit Anand, Canton, MA (US); Brian P. Gearing, Cambridge, MA (US); Sauri Gudlavalleti, Cambridge, MA (US)

Correspondence Address: Timothy J. Oyer, Wolf, Greenfield & Sacks, P.C., 600 Atlantic Avenue, Boston, MA, 02210, US

(21) Appl. No.: 09/858,878

(22) Filed: May 15, 2001

(51) Int. Cl. G01N 3/20

(52) U.S. Cl. 73/849

(57) ABSTRACT

A testing apparatus has an integral load cell element. The apparatus may be used to characterize a property of a sample on, for example, the mesoscale. The apparatus has a frame, at least one actuator and at least one displacement sensor. The apparatus may further include a controller and data acquisition equipment. At least one portion of the frame defines at least one flexure element that is capable of being displaced, by the actuator or a sample, along a rectilinear axis. The frame defining the flexure element has a platform and at least two parallel beams or springs supporting the platform. The portion of the frame defining the flexure element tends to restrict displacement of the sample rectilinearly along an axis that is parallel to the applied force. The arrangement also provides a counter-rotating associated with a cantilever spring assembly. An indentation testing apparatus is has the capability to indent a sample with an indenter. A biaxial testing apparatus has the capability to apply a displacement along two axes. The actuators of the biaxial testing apparatus are de-coupled to remove interaction between the applied forces. The testing apparatus can be tailored to a specific characterization test by selecting an appropriate sample size, geometry, frame material, flexure element geometry, indenter, actuator and displacement sensor. The testing apparatus is capable of measuring 1 μN to 10 N forces with a resolution of 50 μN.

### BACKGROUND OF THE INVENTION

1. Field of the Invention

The present invention relates generally to apparatus and methods for characterizing physical properties of a material including tensile, compressive, and shear properties.

2. Description of the Related Art

The physical properties of a material determine, in part, how the material responds to applied forces and displacements. Therefore, it is important to characterize these properties in order to determine if a material is suitable for a particular application.

Physical properties may be characterized by applying a force to the material and measuring the resulting deformation. The measurement can be converted to a stress-strain relationship from which several physical properties can be determined including modulus and strength. Different types of force can be applied to measure properties in different directions. For example, a tensile, compressive, or shear force can be applied.

Conventional apparatus exist for measuring the physical properties of a material. The apparatus generally include an actuator to apply the displacement to the material, a load cell to measure the resulting force, and a displacement sensor to measure the deformation to the sample. The apparatus are typically assembled by attaching such elements to a supporting frame.

### SUMMARY OF THE INVENTION

The present invention is directed to a testing apparatus and methods used to characterize properties of a material.

In one aspect of the present invention, an apparatus is provided for characterizing a property of a sample comprising an actuator, a displacement sensor and a frame supporting the actuator and the displacement sensor and wherein a portion of the frame defines at least one flexure element.

In another aspect of the present invention, an apparatus is provided comprising a frame having a flexure element, the frame is constructed and arranged to be mountable on a surface that is changeable by a user from a first orientation to a second orientation.

In another aspect, the present invention is directed to an apparatus comprising a frame including at least two beams integral therewith, each beam having a first end integral

In another aspect, the present invention is directed to an apparatus comprising a frame including at least two beams integral therewith, each beam having a first end integral with a first platform, an actuator being supported on the frame and being capable of displacing the first platform a displacement and a displacement sensor being supported on the frame and capable of measuring the displacement of the first platform.

In another aspect, the invention provides an apparatus for characterizing a sample, the apparatus is capable of applying a force to the sample between about 1 μN and about 10 N with a resolution of less than about 50 μN.

In another embodiment, the present invention is directed to an apparatus comprising a frame having a first flexure element integral with a first portion thereof and a second flexure element integral with a second portion thereof, an actuator supported by the frame, the actuator constructed and arranged to displace the first flexure element by a first displacement, a first displacement sensor supported by the frame and capable of measuring the first displacement and a second displacement sensor supported by the frame and capable of measuring a second displacement of the second flexure element.

In another embodiment, the present invention is directed to an apparatus for characterizing a sample comprising a frame having a portion that defines a flexure element, an indenter supported on the frame, an actuator supported on the frame and constructed and arranged to displace the indenter and a displacement sensor supported on the frame and capable of measuring the displacement.

In another embodiment, the present invention is directed to an apparatus for characterizing the sample comprising a first actuator being capable of creating a first displacement along a first axis, a second actuator being capable of creating a second displacement along a second axis, a first displacement sensor being capable of measuring the first displacement, a second displacement sensor being capable of measuring the second displacement and a frame supporting the first and second actuators and the first and second displacement sensors. A first portion of the frame defines a first flexure element and a second portion of the frame defines a second flexure element. The second axis is substantially perpendicular relative to the first axis.

In another embodiment, the present invention is directed to an apparatus for characterizing a sample comprising an actuator, at least one displacement sensor and a frame supporting the actuator and a displacement sensor and wherein the actuator is capable of displacing a first portion of the frame.

In another embodiment, the present invention is directed to an apparatus for characterizing a sample comprising an actuator, a displacement sensor and a frame supporting the actuator and the displacement sensor. A portion of the frame is displaceable by a force from the sample and the displacement sensor is capable of measuring the displacement of the portion of the frame.

In another embodiment, the present invention is directed to an apparatus for characterizing a sample comprising a frame having a first portion and a second portion. The first and second portions capable of being displaced along an axis. The first portion capable of displacing the sample substantially along the axis and the second portion capable of exerting a force on the sample substantially along the axis.

In another embodiment, the present invention is directed to an apparatus for characterizing a sample comprising a frame having a first portion capable of displacing along a first axis and a second portion capable of displacing along a second axis, the first portion capable of applying a first force to the sample along the first axis and the second portion capable of applying a second force to the sample along the second axis.

In another embodiment, the present invention is directed to an apparatus for characterizing a sample comprising at least one actuator, a displacement sensor and a frame supporting the actuator and the displacement sensor, wherein the frame is capable of exerting a first force along a first axis and a second force along a second axis.

In another embodiment, the present invention is directed to a method comprising the steps of displacing a first end of a sample by a first rectilinear displacement along an axis, displacing a second end of a sample by a second rectilinear displacement along the axis and creating a force proportional to the second displacement along the axis.

In another embodiment, the present invention is directed to a method for characterizing a sample comprising the steps of providing a testing apparatus comprising a frame supporting an actuator, a loading displacement sensor and an actuating displacement sensor and a loading flexure element integral with the frame and an actuating flexure element integral with the frame; determining a reactive force curve created by the loading flexure element in response to a loading displacement of the loading flexure element; supporting a first end of the sample in the actuating flexure element and a second end of the sample in the loading flexure element; actuating the actuator to create an actuating displacement in the actuating flexure element and determining the loading displacement in response to the applied force on the sample.

In another embodiment, the present invention is directed to a method comprising the steps of providing a testing apparatus comprising a frame having a sample stage and supporting an actuator and a displacement sensor, the frame defining a flexure element supporting an indenter, supporting the sample on the sample stage, actuating the actuator to create a displacement of the flexure element and the indenter, measuring the displacement and determining the applied force to the sample by comparing the displacement to a calibration curve.

In another embodiment, the present invention is directed to a method comprising the steps of providing a testing apparatus comprising a frame supporting a normal actuator, a translating actuator, a normal loading displacement sensor and a translating displacement sensor, the frame defining a normal loading flexure element and a translating flexure element; supporting the sample in the frame; actuating the actuator to create a normal displacement in the normal flexure element to apply a normal force on the sample; actuating the translating actuator to create a translating displacement in the translating flexure element and measuring the normal loading displacement and the translating displacement.

In another embodiment, the present invention is directed to an apparatus for characterizing a sample comprising an actuator, a displacement sensor and a frame supporting the displacement sensor. A portion of the frame is displaceable by a force from the sample and the displacement sensor is capable of measuring the displacement of the portion of the frame.

In another embodiment, the present invention is directed to a method for producing a testing apparatus comprising the steps of providing a substantially planar billet having a desired thickness, forming a flexure element from a portion of the billet, installing an actuator on the billet and installing a displacement sensor on the billet capable of measuring the displacement of the flexure element.

In another embodiment, the present invention provides an apparatus comprising a flex element having at least two beams, each beam having a first end integral with a first platform, an actuator capable of displacing the first platform a displacement and a displacement sensor capable of measuring the displacement of the first platform.

Other features and embodiments of the invention are described in the following detailed description of the invention.

### BRIEF DESCRIPTION OF DRAWINGS

FIG. 1 shows a uniaxial testing apparatus with a frame that defines a flexure element according to one embodiment of the invention;

FIG. 2A shows the frame of the uniaxial testing apparatus of FIG. 1 during characterization of a sample;

FIG. 2B shows a flexure element of the frame of FIG. 2A during characterization of a sample;

FIG. 3 shows a biaxial testing apparatus with a frame that defines a flexure element according to one embodiment of the invention;

FIG. 4 shows an indentation testing apparatus with a frame that defines a flexure element according to one embodiment of the invention;

FIG. 5 is a copy of a photograph of a tensile testing apparatus used in Example 1;

FIG. 6 is a tensile stress-strain graph of a 644 nm thick gold film sample tested in Example 1;

FIG. 7 is a tensile stress-strain graph of 16.5 μm thick aluminum foil sample tested in Example 2;

FIG. 8 is a force extension graph of a synthetic silk-like fiber sample tested in Example 3;

FIG. 9 is a copy of a photograph showing an indentation testing apparatus used in Example 4;

FIG. 10 is a normal force calibration curve of the flexure element in the testing apparatus used in Example 4;

FIG. 11 is a displacement to voltage chart of the actuator of the indentation testing apparatus used in Example 4;

FIG. 12 is a copy of a photograph showing the indentation into a sample made of Al 6061-T6 with a Berkovich indenter using the indentation apparatus as described in Example 4;

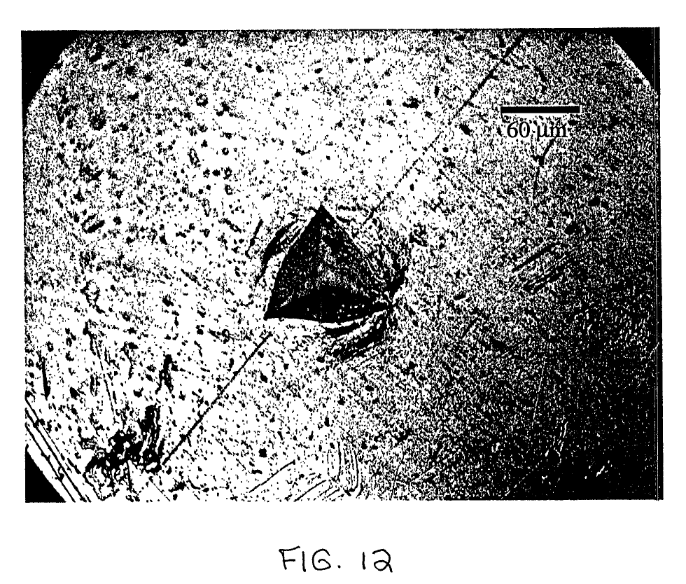

FIG. 13 is a load depth graph of Al 6061 tested with a Berkovich indenter using the indentation testing apparatus as described in Example 4;

FIG. 14 is a graph showing the load to indentation depth into a sample made of soda-lime glass at 0.5 mN/sec. with a Berkovich indenter using the indentation testing apparatus as described in Example 4;

FIG. 15 is a copy of a photograph showing the indentation made into a sample made of a polycarbonate with a Berkovich indenter using the apparatus as described in Example 4;

FIG. 16 is a graph showing the load to indentation depth into a polycarbonate sample with the Berkovich indenter using the indentation testing apparatus as described in Example 4;

FIG. 17 is a graph showing the load to indentation into an EPDM sample with a Berkovich indenter using the indentation testing apparatus as described in Example 4;

FIG. 18 are copies of photographs of glass indented with a Berkovich indenter using the indentation testing apparatus as described in Example 4;

FIG. 19 is a graph showing the load to indentation depth into a soda-lime glass sample with a Berkovich indenter using the indentation testing apparatus as described in Example 4;

FIG. 20 is a copy of a photograph showing the indentation into a single crystal silicon sample with a Berkovich indenter using the apparatus as described in Example 4;

FIG. 21 is a graph showing the load to indentation into a single crystal silicon sample with a Berkovich indenter using the indentation apparatus as described in Example 4;

FIG. 22 is a copy of a photograph showing a biaxial testing apparatus used in Example 5;

FIG. 23 is a calibration curve of the flexure elements of the biaxial testing apparatus used in Example 5;

FIG. 24 is a graph showing the force to voltage response of the normal force actuator of the biaxial testing apparatus used in Example 5;

FIG. 25 is a graph showing the tangential load versus sliding distance between a sample made of Al 6111-T4 and tool steel at a sliding velocity of 6 μm/sec. using the biaxial testing apparatus as described in Example 5;

FIG. 26 is a graph showing the tangential force versus sliding distance of a polycarbonate sample against tool steel at a sliding velocity of 100 μm/sec. generated using the biaxial testing apparatus as described in Example 5;

FIG. 27 is a graph showing the displacement at the interface as a function of sliding distance between tool steel and a polycarbonate sample generated using the biaxial testing apparatus as described in Example 5;

FIG. 28 is a graph showing the tangential force versus the sliding distance of a sample made of Al 6111-T4 against tool steel at a sliding velocity of 6 μm/sec. under a normal load of 967 mN generated using the biaxial testing apparatus as described in Example 5;

FIG. 29 is a graph showing the friction coefficient versus the sliding distance derived from the data as described in Example 5;

FIG. 30 is a schematic showing a sample holder designed to perform a three point bend test as described in Example 6;

FIG. 31 is a graph showing a load to deflection generated using the sample holder shown in FIG. 30 on a 0.01 inch diameter gold wire sample using the testing apparatus as described in Example 6; and

FIG. 32 is a schematic showing a frame according to one embodiment of the invention positioned in a lateral, perpendicular and horizontal orientation.

### DETAILED DESCRIPTION

The present invention is directed to testing apparatus and methods used to characterize properties of a sample. The testing apparatus generally function by applying a force to the sample, for example using an actuator, and measuring the resulting sample deformation, for example using a displacement sensor. In some embodiments, the testing apparatus include at least one flexure element that is coupled to the actuator and/or the sample. As described further below, the flexure element can be designed to ensure that the force applied to the sample and the resulting deformation are substantially along one axis (that is, rectilinear), which advantageously reduces or substantially eliminates parasitic deflections, (that is, deflections along directions other than the axis), that can occur in conventional testing apparatuses. By reducing or eliminating parasitic deflections, highly accurate characterization can be achieved. The apparatus are particularly suitable for characterizing sample using applied forces in the mesoscale range, i.e., between about 1 μN and about 10 N. The apparatus can have a number of different configurations which provide different types of characterization, for example, tensile, compressive, uniaxial, biaxial, and indention.

As used herein, a “flexure element” refers to an element that is deflectable in response to an applied force and can undergo deformation and recover its initial shape.

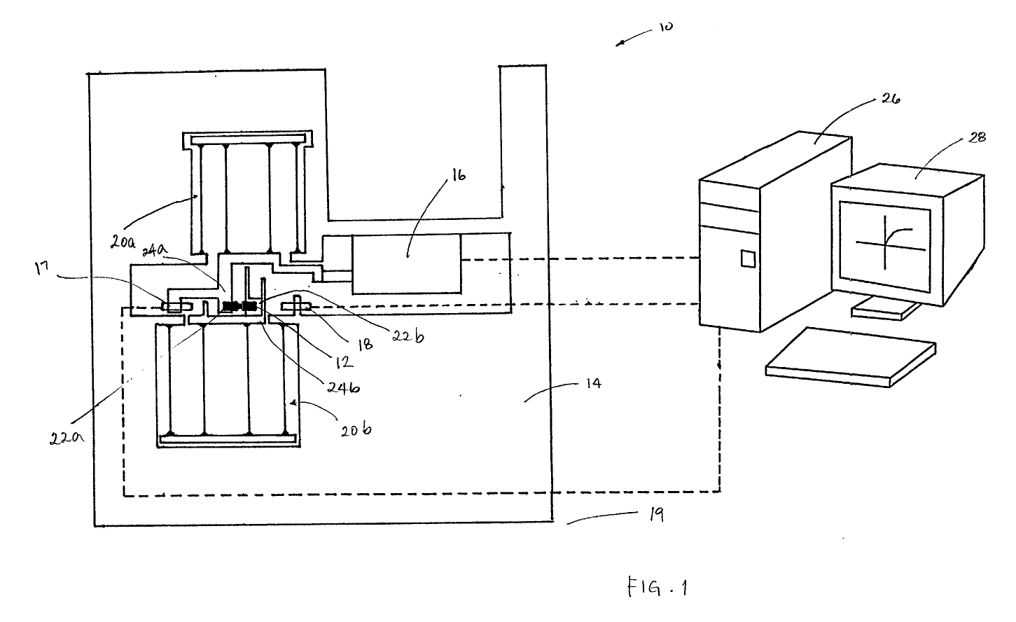

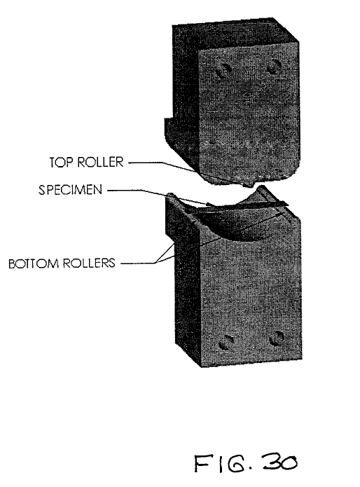

FIG. 1 schematically shows a uniaxial testing apparatus 10 suitable for characterizing tensile properties of a sample 12 according to one embodiment of the present invention. Testing apparatus 10 includes a frame 14, which supports an actuator 16, a first displacement sensor 17, and a second displacement sensor 18. Frame 14, for example, may be mounted to a supporting surface 19. In the illustrative embodiment of FIG. 1 and as described further below, frame 12 defines or forms an actuating flexure element 20a and a loading flexure element 20b. Sample 12 is mounted to frame 14, for example, using grips or sample holders 22a and 22b, and shown in FIG. 30. As shown, sample holder 22a is secured to a distal end 24a of a portion of actuating flexure element 20a and sample holder 22b is secured to a distal end 24b of a portion of loading flexure element 20b. Apparatus 10 typically includes a controller 26 which is capable of receiving or sending signals to actuator 16 and displacement sensors 17 and 18. Optionally, a monitor 28 is associated with the controller for displaying data related to the signals.

It should be understood that other embodiments of the invention may have different designs than the embodiment of FIG. 1. For example, other embodiments may include only one flexure element. Also, the sample may be secured to the frame in a different manner. Additional embodiments are discussed further below.

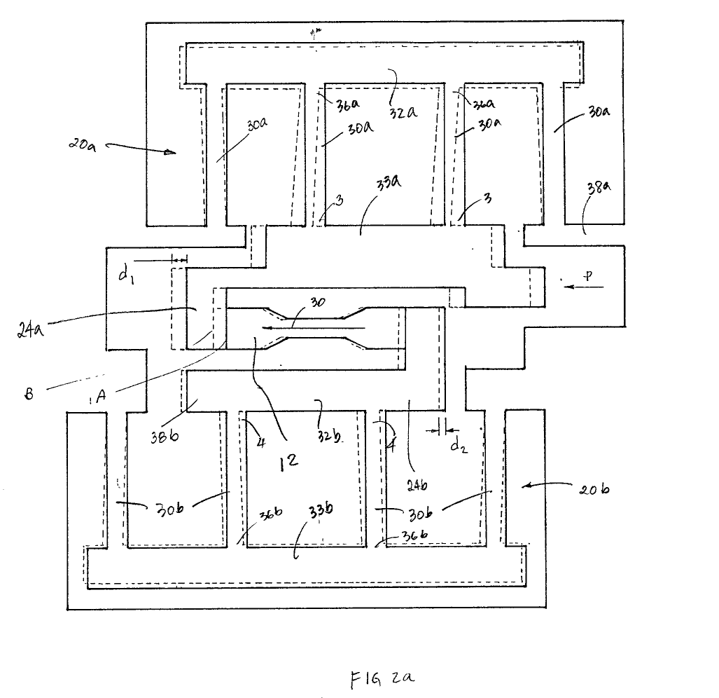

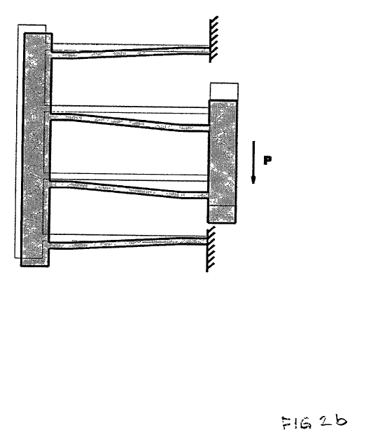

FIGS. 2A and 2B schematically illustrate frame 12 of apparatus 10 during characterization of a sample. The actuator (not shown) is controlled, for example, by a controller, to displace actuating flexure element 20a, which, in turn, provides a force that pulls on sample 12 in a direction 30. A displacement sensor (not shown) measures the displacement, (e.g., d₁,) of distal end 24a of actuating flexure element 20a and transmits a signal representative of the displacement to the controller. The applied force causes deformation of sample 12 and, generally, also displaces the sample in direction 30 from position A, shown as solid lines, to position B, shown as broken lines. In response to the displacement of the sample, loading flexure element 20b is displaced causing it to exert a reactive or resistive force on the sample in a direction that is opposite the direction of displacement. So, the force applied to sample 12 transfers to loading flexure element 20b and creates a displacement of the second flexure element. A second displacement sensor (not shown) measures the displacement, (e.g., d₂), of distal end 24b of loading flexure element 20b and transmits a signal representative of the displacement to the controller to provide a measurement of the applied force. Using the signals transmitted from displacement sensors, the controller may be used to determine the relationship between the force, e.g., the stress, applied to the sample and the resulting deformation, e.g., the strain. For example, the strain may be calculated by dividing the displacement, as measured by the displacement sensor and dividing by the effective cross-sectional area of the sample. Notably, as in a preferred embodiment, if the displacements sensor is supported on a platform of the actuating flexure element, the sensor can directly or relatively measure the displacement of the sample by measuring the displacement of the platform of the loading flexure element. In some embodiments, the controller uses a calibration curve to determine the force-deformation, e.g., the stress-strain relationship, as described further below. A number of material properties of the sample, such as modulus, and strength, amongst others, can be determined by further analyzing the force-deformation relationship.

In the embodiment of FIG. 1, flexure elements 20a, 20b are defined from a portion of frame 12. That is, flexure elements 20a, 20b are an integral part of frame 12. Said another way, the frame and flexure elements form a unitary piece. In some cases, this unitary design is preferred. The unitary design can be effective, for example, in applying force and causing displacement substantially along one rectilinear axis. In particular, the unitary design corrects for slight misalignments that can occur when mounting components, e.g., actuator, flexure elements, to the frame that may cause non-rectilinear forces and deformations. Furthermore, the unitary design can be effective in reducing any overall or system compliance, sometimes referred to as backlash, associated with attaching separate components on a frame. For example, the backlash associated with attaching a separate load cell to a frame is nonexistent in a frame having a integral loading flexure element. However, though the unitary design may be preferred, it should be understood that certain embodiments of the invention may utilize flexure element designs that are separate, i.e., non-integral, from the frame and are mounted to the frame during assembly. That is, components such as the actuator and the displacement sensors need not be supported on the frame and may be supported on a separate supporting stand.

In some embodiments, flexure elements 20a, 20b are preferably designed to deflect in substantially one direction to ensure that the force applied to the sample and the resulting deformation are substantially in one direction. Flexure elements 20a, 20b may have any design which effectively restricts deflection to substantially one direction. Examples of suitable flexure elements include springs such as rectilinear springs and, compound springs amongst others. As described further below, the flexure element may include at least one counter-rotating element to ensure that the flexure element has substantially one axis of displacement. The counter-rotating elements reduce rotation of the flexure element that otherwise can cause parasitic deflections such that the flexure element has substantially one axis of displacement.

In the illustrative embodiment of FIG. 2A, flexure elements 20a, 20b are formed of an arrangement of beams 30a, 30b and platforms 32a, 32b, 33a, 33b which restricts deflection to substantially one direction. Each beam 30a, 30b includes a first end 34 which is connected to a first platform 32a, 32b, and a second end 36a, 36b. Second ends 36a, 36b of a number of the beams are connected to a second platform 33a, while second ends 36a, 36b of the remaining beams are connected to respective portions 40 of the frame. As shown, second platform 33a of actuator flexure element 20a includes a proximal end 38a to which actuator 16 is secured and distal end 24a to which sample 12 is secured; and, second platform 33b of loading flexure element 20b includes a free proximal end 38b and a distal end 24b to which sample 12 is secured. In this embodiment, beams 30a are arranged so that when second platform 33a of actuator flexure element 20a is displaced, e.g., by actuator 16, along its longitudinal or lengthwise direction shown as direction of load P in FIG. 2A. Each beam 30a acts as a counter-rotating element and restricts the displacement of the second platform 33a to substantially along one axis. Similarly, beams 30b are arranged so that when second platform 33b of loading flexure element 18b is displaced, e.g., when the sample is displaced by the applied force, each beam 30b acts as a counter-rotating element and restricts the displacement of the second platform 33b to substantially along one axis. As shown, the beams are substantially perpendicular to the platforms, though other arrangements are also possible including symmetric beam arrangements. For example, the beams may be symmetrically arranged to form W or M configurations.

Flexure element 20, shown in travel or in displacement in FIG. 2A, reduces the rotation and parasitic deflection. In particular, FIG. 2A shows that the two inner beams, with a load P, is applied along a displacement axis, must both move the same total distance because they are rigidly attached to the same surface at each end, platform 24. Also, because both the inner and outer beams may have the same stiffness, and they all share the same load P equally, they must all have the same displacement in an axis that is perpendicular to the axis of displacement, but in opposite directions. So, in net effect, any displacement associated with the inner set of beams is displaced by a displacement that is equal but in opposite direction that results from the outer set of beams. That is, flexure element 18 is suitable for applications requiring moderate and highly rectilinear travel while providing low or moderate stiffness.

Flexure element stiffness, travel or displacement ranges of the flexure elements may be catered or designed to a specific range depending on the type of test, the type of specimen and the configuration of specimen relative to a desired load or displacement while considering the applicable or desired resolution. The following equations can be used by one of ordinary skill in the art to design the apparatus including the flexure element.

The stiffness, k, of a flexure element or a compound flexure spring may be determined according to Hooke's law and beam theory as:

$$k = \frac{P}{v ( 0 )} = \frac{12 EI}{{L}^{3}} \qquad ( 1 )$$

where E is the Young's modulus of the beam material, L is the length of the beam, and I is the area moment of inertia of the cross-section of the beam defined by

$$I = \frac{{bh}^{3}}{12} \qquad ( 2 )$$

where b is the width of the beam cross-section and h is the height. The maximum axial stress in an individual beam may be determined by

$${σ}_{max} = \frac{3 {Ehv}_{max}}{2 {L}^{2}} \qquad ( 3 )$$

The maximum displacement νₘₐₓ, may be limited by the yield stress, σ_{y}, of the material of flexure element reduced by a factor of safety, kₛ. Hence, Equation 3 may be modified to

$${v}_{max} = \frac{2 {L}^{2} {σ}_{y}}{3 {Ehk}_{s}} \qquad ( 4 )$$

It should be understood that the flexure elements can have a variety of other designs including designs that do not include beams and platforms or designs that have beams and platforms arranged in other configurations. In some embodiments, flexure element 18 may be a double compound or dual flexure element having two flexure elements symmetrically disposed about a common traveling axis. This dual flexure element has twice the stiffness but the same maximum travel. This latter configuration may be used in applications requiring higher rectilinearity and resistance to rotations when there exists the possibility of forces perpendicular to the primary axis. It should also be noted that although the apparatus may be designed according to the equations described above, calibration of the apparatus, including the frame stiffness and the controller as well as the actuating and data acquisition electronic components are necessary.

Frame 14 may be selected from a material and designed so that it is capable of supporting at least one actuator and at least one displacement sensor. In embodiments in which frame 12 defines flexure element 20, the frame must be made of a suitable material to perform the function of the flexure element, for example, deflect in response to applied forces. Suitable materials for frame 14 include metals and metal alloys, semiconductor materials such as silicon, solid polymeric materials such as polycarbonate, and reinforced polymeric materials, for example, ceramic filler- reinforced plastics, amongst others. In one set of preferred embodiments, frame 12 is formed from an aluminum alloy, for example, Al 7075-T6. Aluminum alloys, such as Al 7075-T6, are readily machinable into flexure elements that have a sufficient stiffness for most testing purposes, for example, when applied forces are within the mesoscale range. However, it should be understood that other materials may also be suitable for the frame and that the displacement sensor or the actuator do not have to be supported on frame 14 and may be supported on separate supporting structures.

Frame 14 can be made using any of known machining techniques. The particular technique may depend, in part, on the material from which the flexure element is formed. For example, the frame formed from a metal or metal alloy may be produced by machine-cutting, by electro-discharge machining or by water-jet cutting a plate of the metal. When flexure element 20 is formed from silicon, etching techniques are typically used to form the flexure element.

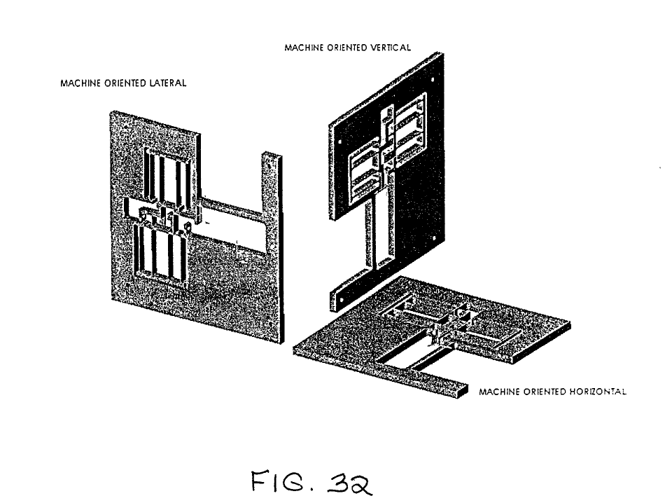

Frame 14 may be mounted to any supporting surface 19 as shown in the illustrative embodiment. Generally, the frame is mounted substantially perpendicular to the supporting surface, though other orientations are possible. Any suitable mounting technique can be used. In some cases, it may be preferable for the frame to be mounted in a manner that isolates the frame (and components supported thereby) from external vibration. It should be understood that, in some embodiments, frame 14 is not mounted to a supporting surface. For example, in some embodiments, frame 14 may include a base that supports the frame but is not mounted to an additional supporting surface. In some embodiment as shown in FIG. 32, the frame is mountable on a base or supporting structure such that the frame is capable of being oriented, relative to the base, perpendicularly, horizontally and laterally. In another embodiment, the frame is mountable in any orientation between the horizontal, lateral and perpendicular orientation.

Actuator 16 provides the force that creates a deformation to the sample. In the illustrative embodiment, actuator 16 serves to create a displacement or at least to partially displace a flexure element which, in turn, applies the force to the sample. Therefore, the actuator is capable of providing a sufficient force to displace the flexure element as required by the testing. The choice of actuator may depend upon several factors including, for example, the desired displacement and the stiffness of the flexure element connected to the actuator. Examples of actuators include, but are not limited to, worm-driven, voice coil or translational stage actuators. Furthermore, actuator 16 may be actuated by controller 26 according to a desired control algorithm including, for example, velocity control and displacement control.

Displacement sensors 17 and 18 respectively measure the applied force and the resulting deformation to the sample. In the illustrative embodiment, the displacement sensors measure these values indirectly. Sensor 17 measures the displacement of distal end 24a of second platform 33a of the actuator flexure element and sensor 18 measures the displacement of distal end 24b of second platform 33b of the loading flexure element. In one preferred embodiment, displacement sensor 16 measures displacements without physically contacting platforms 33a, 33b or sample 22. In this way, superimposed or other forces associated with sensor contact may be avoided. Examples of such non-contact displacement sensors include, but are not limited to, inductive proximity sensors and interferometric-type sensors. Furthermore, displacement sensor 17, 18 is preferably compact and has a wide range of measurement along with a high-resolution capability. Preferably, displacement sensor 16 has a range of at least about 1.25 mm and a resolution of approximately 20 nm. However, the use of a particular sensor depends on other factors including, for example, the type of sample material and the size of the sample.

Sample 12 is typically mounted or supported on frame 14 using sample holders, or other types of fixtures. In some embodiments, the sample holder supports ends or parts of the sample to corresponding platforms or a stage, or at least a part of the sample to the flexure elements. In some cases, the sample holders align or position the sample along a lengthwise direction along the axis of displacement. That is, the sample holders may be configured to minimize any torsional or out-of-plane forces or displacements during testing. In another embodiment, the sample holder is made of a material that is inert or non-reactive to the sample. The sample holder can be designed to thermally and/or electrically insulate the sample from the frame, if desired. One example of a sample holder is schematically illustrated in FIG. 30, which shows a three-point bending fixture. Accordingly, those skilled in the art may readily recognize that the choice of sample holders or configuration of sample holders may depend on several factors including, but not limited to, the type of sample, the type of test and the property or properties to be characterized.

Controller or control system 26, generally provides output signals to actuator 14 and also may receive input signals from displacement sensors 16, 18. Controller 26 may be designed and constructed to provide signals to actuator 14 according to a pre-determined test procedure or according to a control algorithm. For example, controller 26 may be an open loop control that provides an actuation signal to actuator 16 according to a pre-determined or pre-desired displacement rate or velocity. In another embodiment, controller 26 may provide supervisory control in a closed loop or feedback loop in conjunction with signals from one or both of displacement sensors 17, 18. For example, actuation of sample 12 may be performed in displacement or load control depending on, among other factors, the type of sensor used in the feedback loop. Control algorithms may include proportional, integral, differential or combinations thereof. In one preferred embodiment, controller 20 further includes data acquisition capability for recording and monitoring the signals from displacement sensors 17, 18. In some preferred embodiments, controller 26 also processes the output signals to the actuator and the input signals to the displacement sensors to provide a relationship between the force applied to the sample and the resulting deformation to the sample. Controller 26 may also be used in conjunction with a display 28, as described above. Further modifications and variations of controller 26 used with actuator 16 and displacement sensors 17, 18 will occur to those persons skilled in the art.

Referring again to FIG. 1, testing apparatus 10 can be used to apply a tensile force on sample 12. Sample 12 is formed of a material whose physical properties are to be characterized. Sample may be formed from a wide variety of materials including, but not limited to, metals, glasses, polymers, ceramics, composites, and alloys. As mentioned, testing apparatus 10 may be tailored according to the type of sample and the type of characterization desired to be performed. Similarly, samples may also be prepared and tailored depending on the testing apparatus 10 and the property to be characterized. In some cases, the sample has dimensions that have been proscribed by standardized testing techniques (e.g., dog-bone shapes). For example, in some cases when characterizing using mesoscale forces, sample 12 may include dimensions adapted from standard foil testing standards such as ASTM E345. It should be understood that in some embodiments of the invention, the samples may have non-standard dimensions.

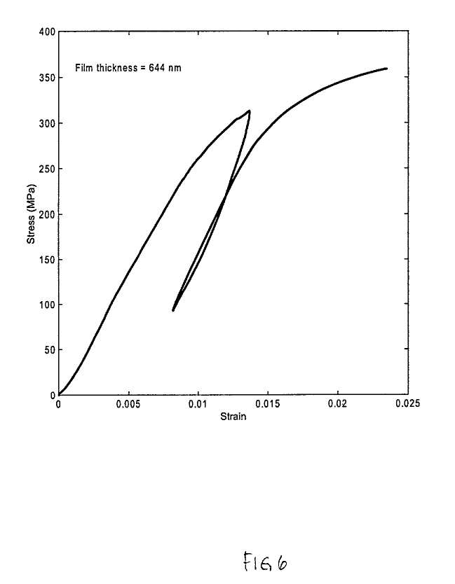

As described above, testing apparatus 10 may be used for tensile testing. Tensile tests generally allow determination of the deformation of a sample up to its breaking point, under a longitudinally applied increasing stress. Characterization of material properties may be obtained to show the tensile stress-strain function of the material. FIG. 6 shows typical tensile stress-strain graph.

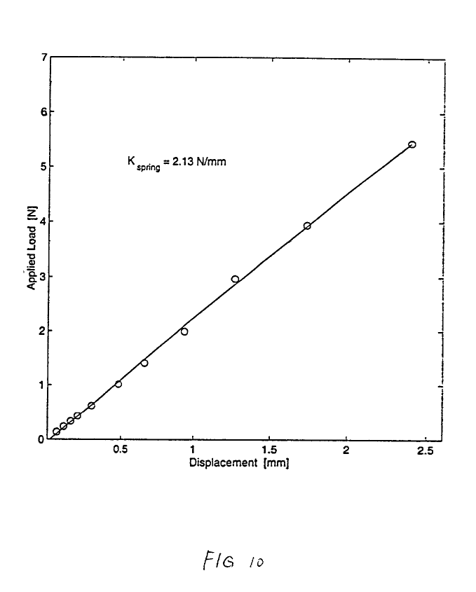

The applied force on a sample may be determined by measuring a displacement of a flexure element having a known stiffness. In particular, because the flexure element preferably behaves as a uniaxial spring, the flexure element generates a reactive force that is proportional to a spring coefficient or stiffness coefficient according to Hooke's law as described above with reference to Eqn. (1). Thus, a calibration curve may be generated by measuring a displacement created by an applied force, such as by using or attaching weights on the flexure element. In a preferred embodiment, the calibration curve may be used to determine the force, such as a reactive force, that a spring, such as a flexure element, generates by measuring a displacement of the spring along a displacement axis. Accordingly, a displacement of the flexure element or a portion of the flexure element, such as the stage, may be measured. FIG. 10 shows a typical calibration curve for a typical flexure element.

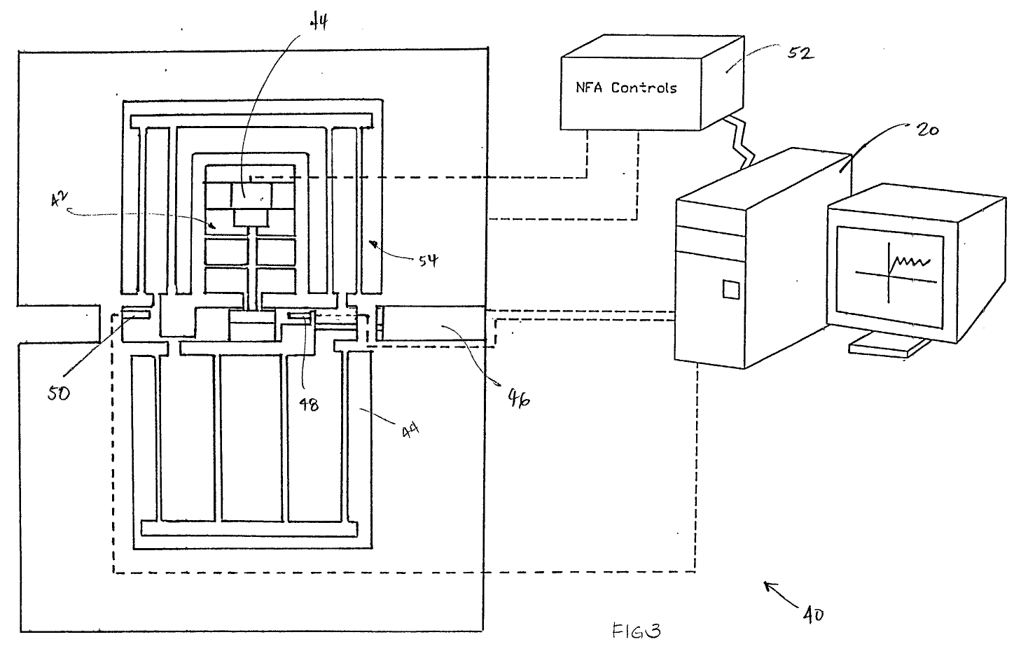

FIG. 3 schematically illustrates a biaxial testing apparatus 40 according to another embodiment of the invention. Biaxial testing apparatus 40 utilizes a number of the same components described above. Biaxial testing apparatus 40 includes at least one normal flexure element 42 and at least one translating flexure element 44 that is formed from or integrated as part of a frame 12. In a preferred embodiment, normal flexure element 42 is defined as a portion of frame 12 such that normal flexure element 42 is a dual flexure so as to form a pair of sets of flexure elements arranged oppositely around the axis of displacement. Biaxial testing apparatus 30 typically has a normal actuator 44, a translating actuator 46, a normal displacement sensor 48, a translating displacement sensor 50 and optionally, a normal force controller 52, each connected and capable of receiving or providing signals to controller 20. Normal actuator 44, typically an actuation voice coil, is oriented on a normal axis relative to a sample. Notably, those skilled in the art may recognize that normal actuator 44 may be any actuator that is capable of applying a normal force on a sample along the normal axis. Translating actuator 46 is typically oriented to provide a translating displacement that is, in one embodiment, substantially perpendicular to the normal actuator force axis. Thus, in one embodiment, biaxial testing apparatus 30 may be used to apply a normal force and a translating force on a sample, simultaneously or independently and in particular, to characterize the friction and shear properties of a sample. Sensor 48 and 50 and actuators 46 and 48 can be supported by any known method such as by welding, riveting, screwing or bolting on frame 12. The normal displacement may be measured by incorporating two symmetrically disposed non-contacting sensors into a flexure element.

In certain preferred embodiments, normal actuator 46 acts independently of translating actuator 48. In some cases, normal actuator 46 provides a normal force that is decoupled from a translating force. As shown in the embodiment shown in FIG. 3, normal actuator 46 may be decoupled from translating actuator 48 by supporting normal actuator 46 in a normal flexure element that is formed as part of a portion of frame 12. Biaxial testing apparatus 30 further comprises a second translating flexure element 54 that provides a rectilinear displacement that is, in one preferred embodiment, substantially perpendicular to the axis of the normal displacement.

The stiffness of the normal actuator and the shear load flexure element may be determined by calibration with weights as described above relative to calibrating the flexure element in FIG. 1. In some embodiments, normal and translating displacements are measured with inductive non-contacting displacement sensors. In some embodiments, the displacement of the translating flexure element may be measurable up to 6.5 mm with a displacement resolution of about 4 nm. The normal force may be determined from about 1 μN to about 10 N and with a resolution of less than about 50 μN and translating forces can be measured from about 1 μN to about 10 N and resolved to within 200 μN. It should be noted that those skilled in the art may recognize that the apparatus, for example, may be designed and constructed to have a flexure element stiffness that is a factor of 10 or any other convenient factor relative to loading flexure element displacement. Thus, a loading flexure element displacement sensor can be used to measure the displacement and the reactive force would be determined by multiplying by the measured displacement by the factor of 10. Thus, the use of a controller or a calibration curve may be avoided advantageously by designing the apparatus.

The force applied by a voice coil may be determined by correlating the applied voltage or applied current and subtracting the reactive force generated when the voice coil actuator displaces a portion of the dual flexure element.

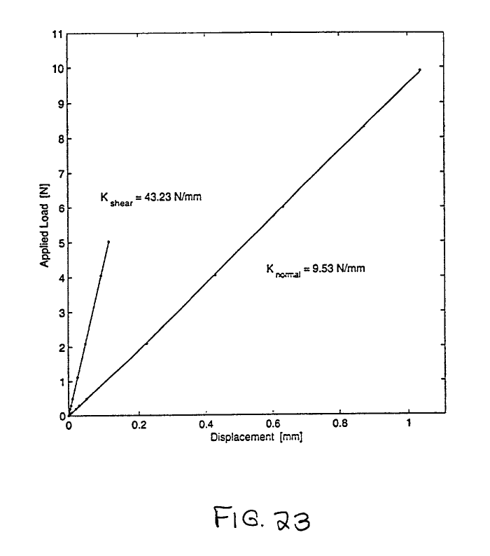

With the sample in place, a linear voltage ramp signal may be sent to normal actuator 36 and the displacement may be monitored. A typical calibration curve for the normal actuator and the translating or shear actuator is shown in FIG. 23.

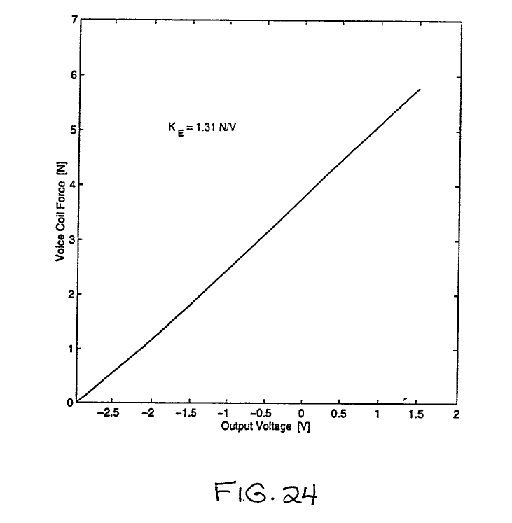

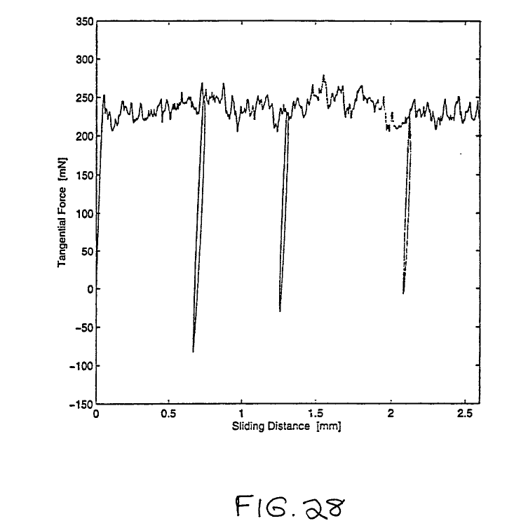

The normal force may be determined by using a calibration curve relative to the voltage applied to the normal actuator, as shown in FIG. 24. FIG. 28 shows a typical tangential load versus sliding distance curve generated using biaxial testing apparatus 40 with Al 6111-T4 against tool steel at a sliding velocity of about 6 μm/sec.

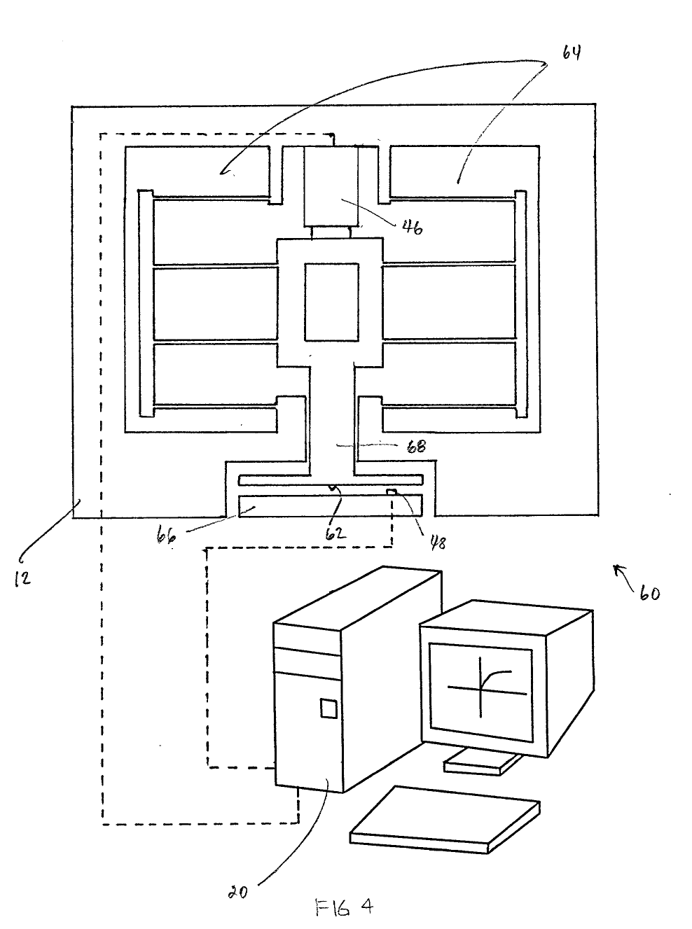

In another embodiment, shown schematically in FIG. 4, an indentation testing apparatus 60 comprises an indenter 62 supported on a dual flexure element 64. Dual flexure element 64 is formed or defined as a portion of frame 12. Indentation testing apparatus 60 further comprises a normal actuator 46, a normal displacement sensor 48, a sample stage 66 and a controller or control system 20. Dual flexure element 64 is analogous to normal flexure element 44 described in the biaxial testing apparatus and substantially similar to dual flexure element 42 of the biaxial testing apparatus described above. The use of the dual flexure element reduces or substantially eliminates the potential for rotation or parasitic deflections that result from imperfections in the machining or manufacturing of indentation testing apparatus 60 or to variations in the elastic properties of the frame material.

Indentation testing apparatus 60 also has a centerpiece 68 that is attached to an actuator and, may be substantially non-compliant compared to dual flexure element 64. Normal actuator 46 is supported and arranged on frame 12 and is capable of receiving an input signal and actuating to displace centerpiece 68 along an axis of displacement. In another embodiment, normal actuator 46 is capable of exerting a force that is proportional to an applied current or an applied voltage.

Indenter 62 is also supported on centerpiece 68 so that it may travel substantially along the axis of displacement. Stage 66 is constructed and arranged to support a specimen or a sample (not shown) and is substantially non-compliant compared to the sample when actuator 46 is actuated. In one embodiment, actuator 46 displaces centerpiece 68 which in turn displaces indenter 62 into the sample. Normal displacement sensor 48 is preferably a non-contact sensor that is capable of measuring the displacement of centerpiece 68 or indenter 62 into the sample.

The force applied by the indenter depends upon the actuator and the stiffness of dual flexure element 64. In a preferred embodiment, actuator 46 applies a force that can be calibrated relative to an applied voltage or applied current and dual flexure element 64 may be characterized according to a spring stiffness. In indentation operation, the force applied to a sample, may be determined by subtracting the resistive force of dual flexure element 64 from the applied force generated by normal actuator 46. The design of indentation testing apparatus 60 depends on several factors including, for example, the stiffness of frame material 12, the thickness of dual flexure element 64, the material of the sample, the type of indenter used and the amount of force that can be generated by normal actuator 46. Further modifications and equivalents of the indentation apparatus will occur to those persons skilled in the art and may include, for example, the use of open or closed loop control or the use of various types of indenter geometries.

Indentation testing apparatus 60 can be used to perform microhardness tests, which drive a diamond tip into a sample, such as a metal, a ceramic or a polymer, to a depth of a few microns require forces ranging from about several millinewtons to a few newtons.

In another embodiment, tensile testing apparatus 10, biaxial testing apparatus 30 or indentation testing apparatus 60 may be used with various sample holders that are designed to support or provide a specific or desired deformation or displacement on a sample. That is, depending on the type of sample, the type of testing apparatus or the property to be characterized, a particular sample holders may be used. For example, the sample holders shown in FIG. 30 may be used in any of the above to test a sample in a three-point bend test.

Notably, each of the apparatus of the present invention may be used to characterize a property of a sample at the mesoscale. As used herein, mesoscale is defined as forces ranging from about 1 μN to about 10 N, and/or displacements ranging from about 10 microns to about 10 millimmeters. For example, a mesoscale metallic film or foil having a thickness of about 1 to about 10 μm thick and about 1 mm wide may be tested under a mesoscale tensile load to a stress of about 500 MPa. In some cases, the apparatus are designed to characterize properties within specific ranges in the mesoscale such as between about 1 μN and about 100 μN; in some cases, between about 10 μN and about 1 mN; in some cases, between about 100 μN to about 10 mN; and between about 10 mN and about 1 N. The range used will depend, in part, upon the sample.

Advantageously, each of the apparatus of the present invention may be used to characterize properties of the sample with a high resolution within the mesoscale. For example, it is possible to characterize a physical property of a sample under forces or loadings of between about 1 μN and about 10 N with a resolution of less than about 50 μN. In some cases, even lower resolutions are desired such as resolutions of less than about 25 μN or less than about 15 μN. Lower resolutions may be desireable when testing samples at low forces (e.g., less than 100 μN). Even resolutions of less than about 10 μN are achievable because depending on the accuracy of the data acquisition equipment and the sensors used. It should be understood that each of the resolutions may be applicable to characterization within each of the mesoscale ranges described herein.

As used herein, resolution refers to the minimum resolvable value or minimum change that can be measured. Resolution is typically dependent on the noise, typically the background noise, associated with the sensor and the data acquisition system of the controller. Advantageously, the frame having integrated flexure elements reduces inaccuracies that are associated with backlash or compliance that typically inherent in multi-component systems. In particular, because the load cell, in some aspects of some embodiments, is defined as a part of the frame, there is no compliance. Similarly, there is no compliance associated with an actuating element because the actuating element is defined as part of the frame. This reduction in compliance can improve the resolution of the apparatus of the invention.

The present invention will be further illustrated by the following examples, which are illustrative in nature and not to be considered as limiting the scope of the invention.

### EXAMPLE 1

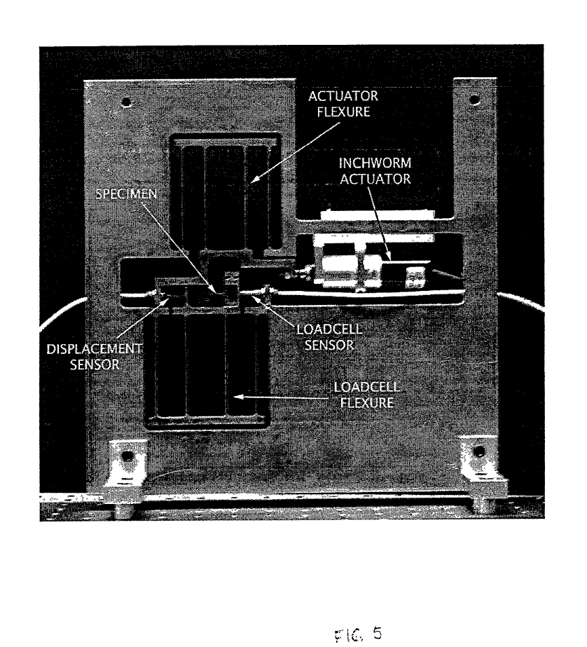

In this example, a unitary testing apparatus was constructed and used to characterize the tensile stress-strain property of a representative sample. A monolithic or unitary testing apparatus, as shown in FIG. 5, was electro-discharge machined from a 12.7 mm thick single plate of aluminum alloy 7075-T6. The apparatus is substantially similar to the apparatus shown in FIG. 1 and, as shown in the photograph of FIG. 5, has a frame a portion of which was cut to define an actuator flexure (ACF) and a load cell flexure (LCF).

An inchworm actuator was installed so as to allow a platform, formed as part of the actuator flexure, to translate along an axis by a rectilinear displacement. The actuator was selected based on considerations pertaining to minimum tolerable strains and maximum required extensions. In this case, the inchworm actuator was model number IW700 available from Burleigh Instruments (Victor, N.Y.) having a minimum step size of about 4 nm and a maximum range of actuation of about 6.35 mm. The actuator may be controlled under velocity control with a minimum velocity of about 0.1 μm/sec. and a maximum velocity of 1.5 mm/sec. A non-contact displacement sensor, model number SMU9000-5U available from Kaman Instrumentation (Colorado Springs, Colo.) was installed on the frame so as to measure the displacement of the platform when the actuator is actuated. The non-contact displacement sensor had a nominal range of 1.25 mm with a resolution of approximately 20 nm. It is noted that this design may be readily adapted to test a wide range of loads and displacements by suitable choice of dimensions, actuators and sensors. The flexure elements were formed to have beams that were about 75 mm long and a width of about 0.8 mm. The ends of the beams were connected to platforms with a fillet radius of about 4 mm to reduce or eliminate stress concentrations. The flexure elements had a maximum permissible deflection of approximately 6 mm calculated based on Eqn. (4). The load cell flexure element, calibrated by hanging precision weights and measuring the displacement, was found to be highly rectilinear and had a stiffness of about 1.2 N/mm. The apparatus had a measurement range of up to 1.5 N with a resolution of about 25 μN.

To calibrate the flexure stiffness, various weights with known masses were connected to each flexure element at or near the location where a specimen would be mounted. The displacement or strain measurement as measured by the displacement sensor was recorded for each of the various weights. The stiffness of the flexure element was then determined by dividing the force associated with each of the various weights by each of the measured corresponding displacements and performing a linear regression computation on total data obtained from all weights.

The testing apparatus was placed on a vibration isolated support. The apparatus was oriented laterally to reduce out-of-plane deflection because of gravity. Notably, the apparatus can be oriented to align the testing axis parallel to the ground or perpendicular to the ground.

Data acquisition to measure the displacement was performed by using a data acquisition I/O board model number PCI6035E available from National Instruments (Austin, Tex.). Each test run was monitored and controlled using a Compaq Deskpro EN550 Pentium II 550 MHz computer running National Instruments LabVIEW Version 5.0 software.

The platforms of each flexure element had threaded holes for installing grip configurations. Notably, this flexible design allows the use of several types of grips or fixtures such as tension grips, mandrels for bend testing, platens for compression testing and fixtures for indentations or combinations thereof to characterize the property or properties of a sample.

The apparatus compliance, in tension, was measured by clamping together both platforms with a rigid link and recording the measured extension under increasing loads. The apparatus compliance represents or is a measure of the flexibility of the overall assembled apparatus and may contribute, at least to some degree, to any error of measurement and consequently reduces the measurement accuracy. Because the ideal extension in this case should be zero, any measured extension was determined to be a result of compliance. The apparatus compliance in tension after several tests was evaluated to be about 1500 N/mm. Similar tests indicated that the apparatus was stiffer under compression.

Tensile tests were conducted on free-standing gold thin film samples deposited on silicon wafers. The samples were dogbone-shaped with a gauge length of either 2.5 mm or 4 mm and a gauge width of 1 mm. The shape of the samples was adapted based on ASTM foil tension testing standards, ASTM E345. The radius of the fillets at the end of the gauge section was 1.5 mm. One end of the sample was installed on the platform or stage connected to the actuator flexure element and the other end of the sample was installed on the platform connected to the load cell flexure element. The actuator was actuated to displace the actuator flexure element. This displacement was measured by the displacement sensor. Because the sample or specimen was attached to the actuator flexure element, the sample was, accordingly, displaced, at least to some extent. The other end of the sample, attached to the load cell flexure element was displaced by a similar distance as measured by the load cell displacement sensor. The specimen was attached to flat aluminum sheet platens which were attached to the load cell and actuator flexure elements. These sacrificial platens had minimal or negligible compliance while not directly applying glue to the frame itself.

The displacement sensors provided signals to the I/O board (not shown). The load cell sensor displacement was then compared to a calibration curve to determine the applied force of the sample. The displacement or strain resulting in an elongation of the sample was determined by a displacement sensor supported on the actuator flexure element measuring the relative change to the load cell flexure element. The stress-strain data from the single tensile test, shown in FIG. 6, was generated using the controller from the signals generated by the displacement sensors.

Notably, significant curling of the specimen after failure was observed. The Young's modulus, calculated from the unloading portion of the graph, was found to be about 72 GPa, which is close to the modulus for bulk polycrystalline gold. The yield stress was determined to be about 250 MPa and is consistent with other test results on thin film gold samples. The ultimate stress was determined to be about 350 MPa and the strain to failure of about 1.6% were also in close agreement with known references.

This example shows that the testing apparatus can generate experimental information on free-standing thin films of known samples with high resolution and repeatability in the mesoscale range. Also, the example shows that the testing apparatus can generate data that correlates with available data.

### EXAMPLE 2

The testing apparatus shown in FIG. 5 was used to test aluminum foil samples in tension. Samples were prepared from commercially available aluminum foil having a thickness of about 16.51 μm. The samples were dogbone-shaped having a 1 mm gauge width, 7 mm gauge length and 1.5 mm fillet radius leading to a 3.5 mm grip section. These mesoscale dimensions were adapted by scaling down ASTM foil testing standards, ASTM E345.

The samples were installed on the platforms of the testing apparatus by securing ends of the samples to grips or fixtures and clamping these fixtures to each of the platforms. Notably, the grips or gripping sections may also be supported or installed on the platform sections by using an adhesive.

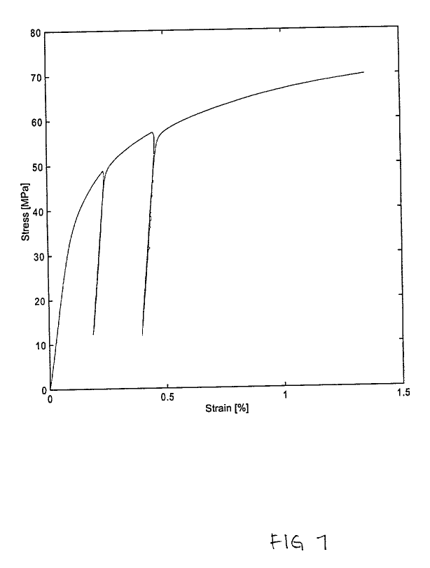

FIG. 7 shows the stress-strain graph obtained from testing an aluminum foil sample using the procedure described in Example 1. The yield stress was determined to be about 35 MPa and is comparable relative to available data on pure aluminum. A finite element analysis was conducted to simulate the geometry of the sample and estimate the sample effective gauge length during elastic straining. The average Young's modulus was calculated from several tests on aluminum foil and was found to be about 65 GPa, which is in reasonable agreement with known data. Thus, the testing apparatus can be used to characterize material properties at the mesoscale. Moreover, the data obtained is relatively free of noise and is repeatable and reliable.

### EXAMPLE 3

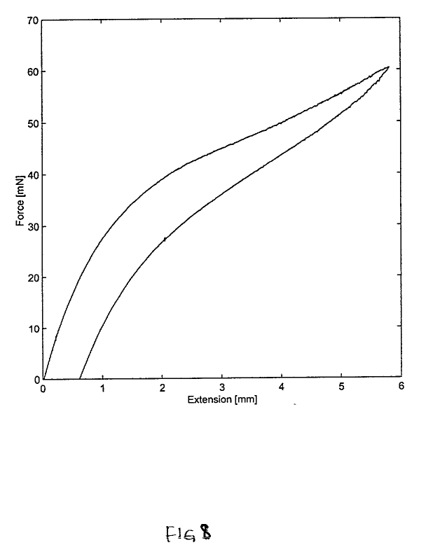

The testing apparatus shown in FIG. 5 was also used in tensile testing synthetic silk-like fibers, a thermoplastic elastomer developed by the Fluid Mechanics Group in the Department of Mechanical Engineering at the Massachusetts Institute of Technology from a plasticized rubber copolymer of styrenic block copolymers, such as KRATON™ available from KRATON™ Polymers Business (Houston, Tex.). The fiber was made to imitate spider silk, especially for its high stretching and strength to weight ratio. FIG. 8 shows the load displacement graph obtained on a synthetic silk fiber with an initial diameter of about 100 μm and an initial length of about 2.6 mm.

This example illustrated the capability of the testing apparatus to test extremely soft materials at very low loads and significantly higher strains in contrast to the previous two examples wherein Example 1 demonstrated testing at low-load with low-strain, wherein Example 2 demonstrated testing at high-load with low-strain and wherein Example 3 demonstrated testing at low-load with high-strain.

### EXAMPLE 4

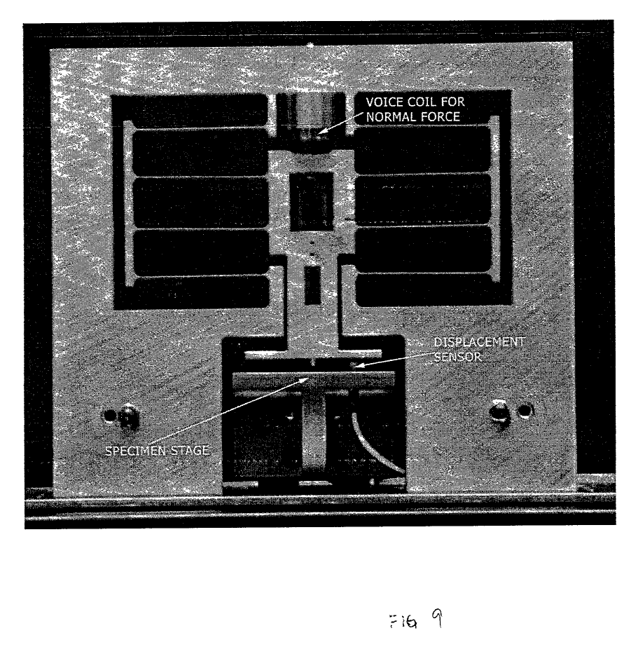

In this example, an indentation testing apparatus was constructed and used to characterize the indentation properties of several samples to illustrate that the apparatus may be tailored, depending on the testing requirements to a variety of testing conditions. FIG. 9 shows a testing apparatus substantially similar to the apparatus schematically shown in FIG. 4. This uniaxial testing apparatus was used to perform indentation tests. Notably, this apparatus may be used to perform compressive tests on a sample.

A standard Berkovich indenter with a custom designed threaded shank was attached to the loading stage of the dual flexure element. The sample was installed in the specimen stage. The testing apparatus was aligned to orient the loading axis perpendicular to the ground. A voice coil was used as a normal actuator to provide a normal displacement.

Indentation tests were conducted on soda-lime glass, aluminum alloy, EPDM and polycarbonate polymers.

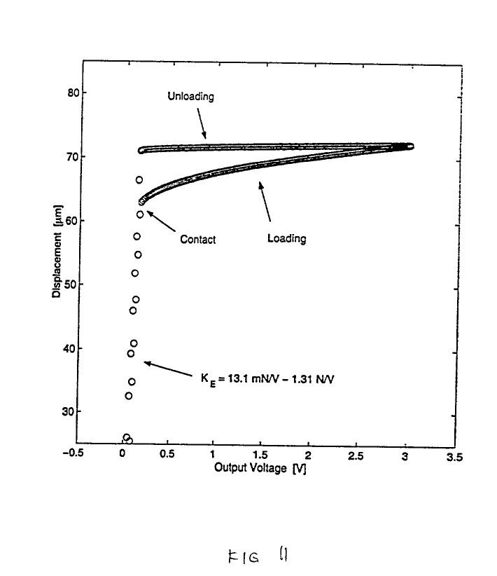

The displacement relative to the output voltage of the voice coil actuator was characterized according to the graph shown on FIG. 11. The force applied by the indenter was determined by subtracting the reactive force of the dual flexure element from the force generated by the voice coil actuator once contact of the specimen occurred. The reactive force of the dual flexure element was calibrated with respect to its own deflection and the input signal to the voice coil, during each test before the specimen was loaded. That is, once the specimen was loaded, the reactive force of the dual flexure element was inferred from the recent “in-situ” or “real-time” calibration. This ensured maximum accuracy and reliability of data, and rendered the testing method significantly less susceptible to variations in testing conditions, such as environmental conditions.

The thickness of the beams forming the flexure element was about 0.8 mm and the length of each beam was about 75 mm. The unitary frame was constructed by water jet cutting, using a water jet abrasive machine, a 12.7 mm thick Al 7075-T6 plate. After the water jet cutting, the surfaces of the frame were carefully milled flat and smooth. The stage was formed from tool steel hardened to HRC60 and mounted on a Z-axis translation stage available from New Focus (San Jose, Calif.)

The equivalent spring stiffness of the flexure element was determined by manual calibration with weights. The measured load-displacement was found to be linear with a spring stiffness of about 2.131 N/mm.

Normal actuation was performed using a voice coil actuator, an electromagnetic current-driven force actuator. The voice coil, model number LA13-12-00A available from BEI Kimco Magnetics Division (San Marcos, Calif.) had a total force range of about 10 N. The voice coil actuator was driven with a low-noise amplifier, model number BTA-28V-6A-3U-HV available from Precision Microdynamics, Inc. (Victoria, Canada). The amplifier was powered by a low-noise and low-ripple power supply, model number E3648A available from Agilent (Palo Alto, Calif.). The input command signals to the amplifier were generated by using data acquisition control. The data acquisition board had a plus or minus 10-volt input and output voltage range. The input voltage to the amplifier was scalable depending on the desired force range. The maximum force range used was 7 N with a resolution of 50 μN.

To calibrate the voice coil actuator, a linear voltage ramp was sent to the voice coil and the displacement of the centerpiece was measured as a function of the input voltage. This produced a calculated transfer function of about 1 N/V. That is, the voice coil current was increased while measuring the flexure displacement. The flexure displacement was then correlated to the flexure force by using the stiffness and displacement relationship.

Displacements were measured using inductive non-contacting displacement sensors similar to those used in the examples above. For large displacements, a set of sensors with a range of 1.25 mm and a resolution of 20 nm were used. For small displacements, a set of sensors with a range of about 50 μm and a resolution of 5 nm were used.

Micro-indentation tests were performed on a variety of materials. The hardness values for these materials range from about 1.5 GPa to 0.18 MPa, with applied loads of several newtons and displacements depths of between about 10 to about 550 μm.

The aluminum specimen was polished to a mirror finish with a 0.1 μm diamond slurry and the remaining specimens were machined so that the surface to be indented was parallel to the opposite face. To prevent any sample motion while testing, the samples were clamped in place with a commercial C-clamp.

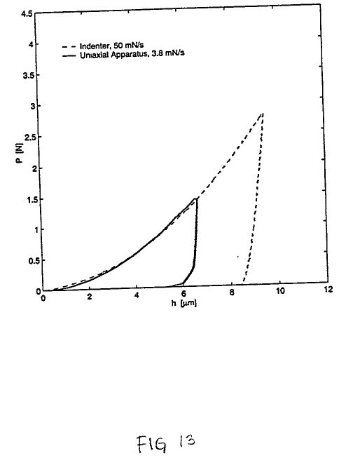

A load displacement, P-h, curve was generated for each of the samples. FIG. 13 shows the load depth graph obtained with a Berkovich indenter on Al 6061. The aluminum sample was loaded to about 3 N at a constant rate of about 50 mN/sec. FIG. 13 also shows the micro-indentation test carried out on mirror-polished Al 6061-T6 samples from a different stock. The loading rate was about 3.8 mN/sec.

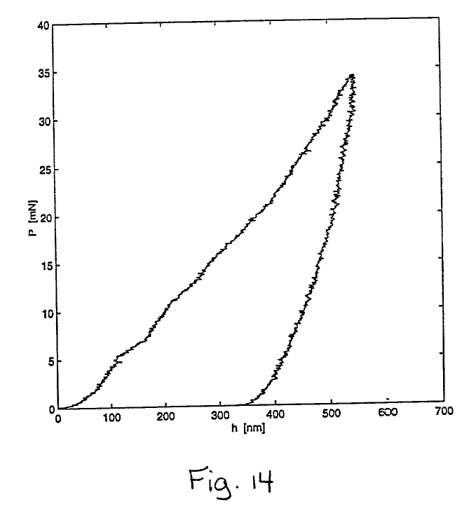

FIG. 14 shows a load depth graph obtained using a Berkovich indenter on soda-lime glass at a loading rate of about 0.5 mN/sec. This demonstrated the range of loads and displacements attainable.

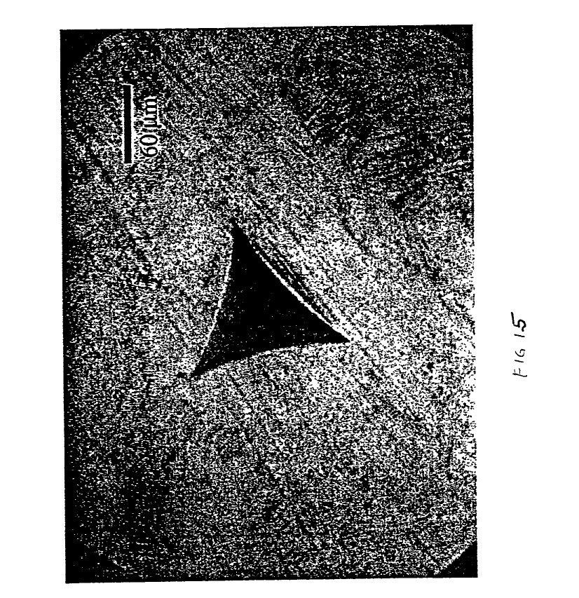

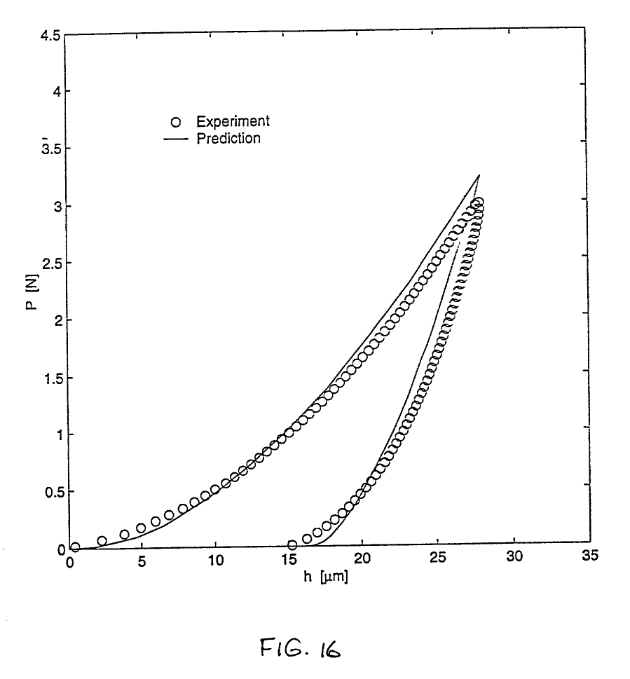

FIG. 15 is a copy of a photograph of a polycarbonate after being indented with a Berkovich indenter using the apparatus shown in FIG. 9. Correspondingly, FIG. 16 shows a load to depth graph of the indented polycarbonate material shown in FIG. 15. This result, when compared with FIG. 14, indicated the ability of the testing apparatus to test a variety of materials from hard glasses to relatively soft polymers.

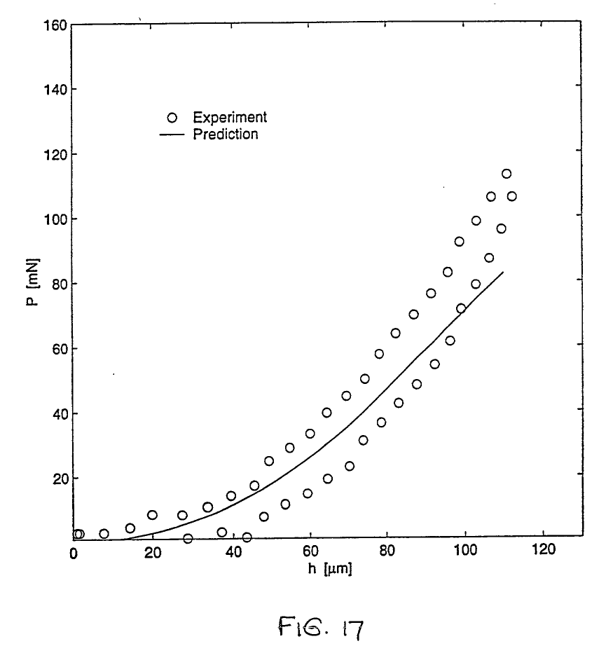

FIG. 17 shows another load-depth graph obtained using a Berkovich indenter using the apparatus of FIG. 9 on EPDM rubber. The graph shows a strong correlation between the predicted load to depth response as computationally predicted by a constitutive model calibrated to macroscopic tests relative to the measured load to depth response. The indentation test demonstrated the capability of the testing apparatus to perform tests on very soft materials.

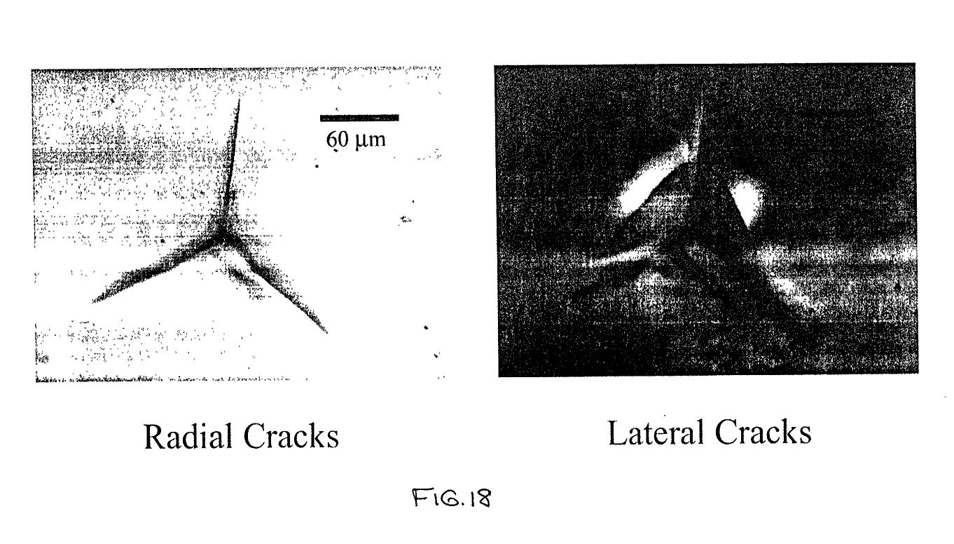

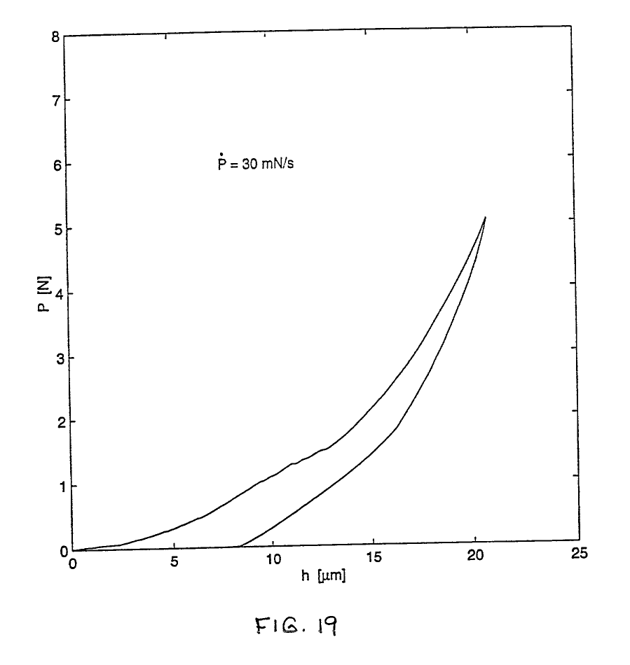

FIG. 18 are copies of photographs of glass after being indented with a Berkovich indenter using the apparatus shown in FIG. 9. Correspondingly, FIG. 19 shows a load to depth graph of the indented soda-lime glass shown in FIG. 18. Thus, the testing apparatus was used to conduct investigations of crack initiation and propagation in brittle media.

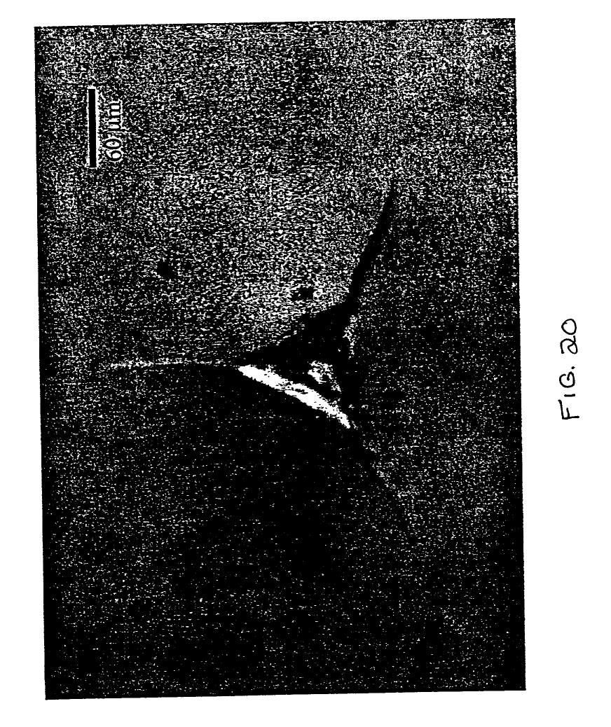

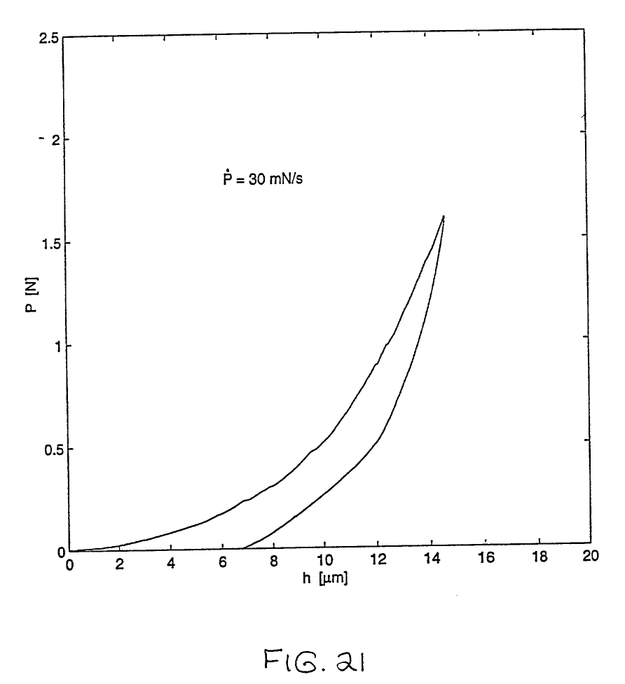

FIG. 20 is a copy of a photograph of a single crystal silicon sample after being indented with a Berkovich indenter using the apparatus shown in FIG. 9 and FIG. 21 shows the corresponding load to depth graph of the silicon sample. Again, crack initiation and propagation studies were performed.

### EXAMPLE 5

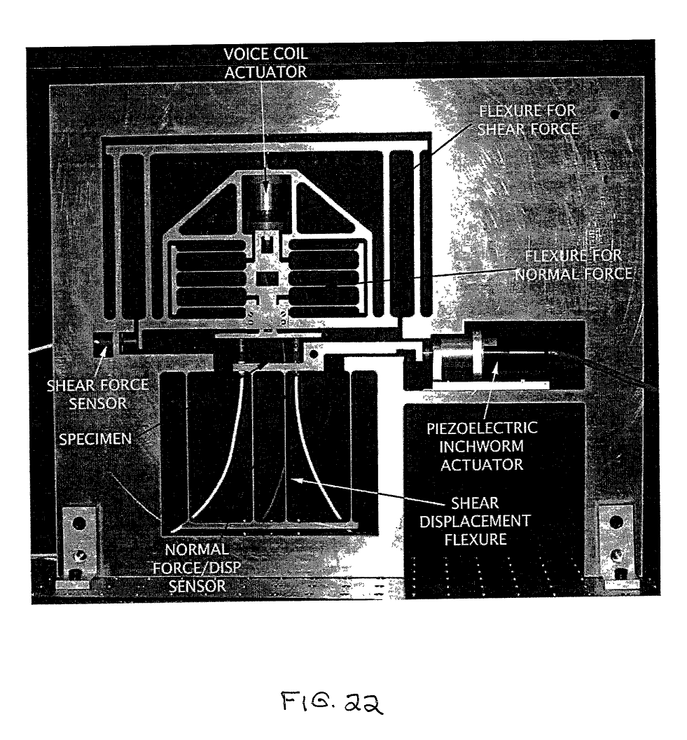

A biaxial testing apparatus, shown in FIG. 22, was constructed according to the schematic shown in FIG. 3. The same voice coil actuator and electronics used in the indentation testing apparatus was used as a normal axis actuator and incorporated into the biaxial testing apparatus. A translating displacement was created by forming a translating flexure element from a portion of the frame. The translating flexure element provided a displacement along an axis that was substantially perpendicular to the axis of displacement of the normal flexure element. The apparatus essentially incorporated the flexure configuration used in the indenter in such a way as to decouple or remove any influence that may result between a translating tangential displacement and a normal displacement.

The displacement of the normal axis was measured in a similar manner as that described in the indentation testing apparatus described above. This biaxial testing apparatus was used to characterize shear and friction properties of samples. The frame of the apparatus was constructed by water jet cutting a 12.7 mm thick Al 7075-T6 plate. The thickness and lengths of the beams of the normal force flexure element was about 0.8 mm and about 52 mm, respectively. The shear or translating flexure element load beams had a thickness of about 4.75 mm and a length of about 125 mm. The thickness of the translating actuating flexure element was about 1 mm and a length of about 117 mm. Critical surfaces were milled flat and smooth from front to the back. The tooling and sample holders or fixtures were made from D2 tool-hardened steel to about HRC60 and ground flat to mate with the surfaces of the sample.

The stiffness of the normal force actuator and the shear load flexure element were determined by manual calibration with weights in a procedure similar to that described in Examples 1 and 4. FIG. 23 shows the calibration curves for the shear flexure element and the normal flexure element.

The normal and shear displacements were measured using inductive non-contacting displacement sensors. The normal force was resolved to within 50 μN by utilizing a voltage divider for the control of voltage to the voice coil actuator and the shear forces were resolved to within 200 μN. The translation displacement actuator had a range of 6.35 mm with a displacement resolution of 4 nm.

Friction experiments were carried out on 0.96 mm thick by 1.83 mm by 1.83 mm Al 6111-T4 samples and on 8 mm thick by 2.48 mm by 2.48 mm polycarbonate samples. The aluminum samples were sheared from a larger sheet whereas the polycarbonate was cut from larger stock and then annealed at 145° C., for about two hours. Most materials were tested against a surface made from tool steel with a ground flat surface at a normal load of 1 N for the aluminum and 0.674 N for the polycarbonate. This corresponded to a normal stress of 0.3 MPa and 0.11 MPa for the aluminum and the polycarbonate samples, respectively. The translating velocities, generated by the translating actuator, were 6 μm/sec on the aluminum samples and 100 μm/sec. on the polycarbonate samples.

FIG. 24 shows the force response curve for the voice coil actuator relative to the applied voltage, which provides the calibration of the electronics that control the normal axis.

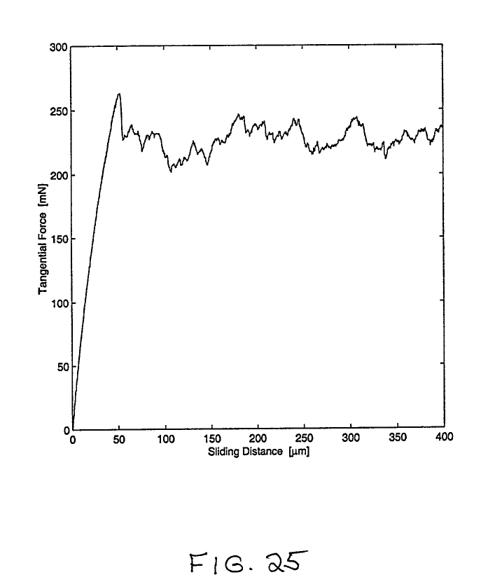

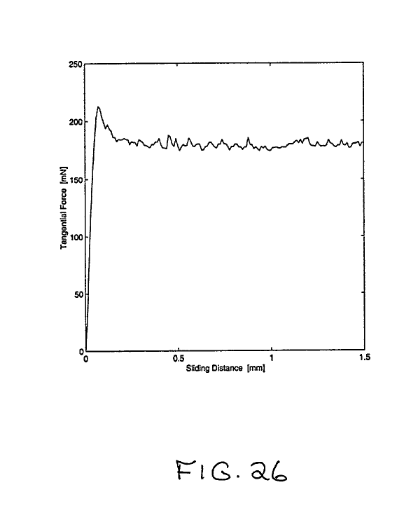

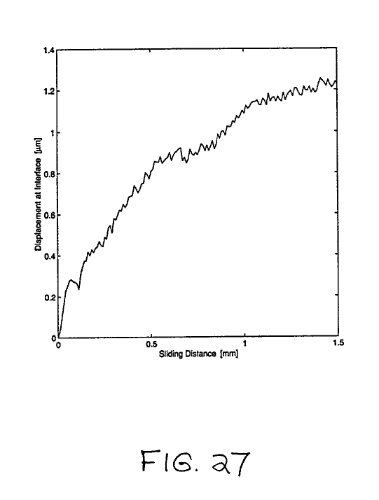

FIG. 25 shows the tangential or translating load versus sliding distance of tool steel on an Al 6111-T4 sample and FIG. 26 shows the translating force relative to the sliding distance of the tool steel against a polycarbonate sample. These figures show that the can measure a shear force of between about 175 to 250 mN with a resolution of about 200 μN. FIG. 27 shows a graph of the normal displacement versus the sliding distance for tool steel on the polycarbonate sample. FIG. 27 shows that the measured motion at the interface indicates that the sample moves closer to the tool as sliding progresses. This behavior is believed to be reasonable because as sliding is imposed, the asperities of the samples wear away and bring the surfaces closer together.

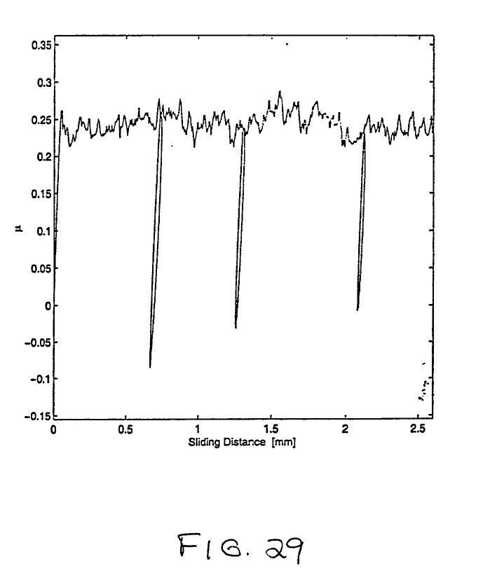

FIGS. 28 and 29 show experimental motivation for adhering-slipping models of interface friction of unlubricated Al 6111-T4 against tool steel under an applied normal force of about 967 mN, normalized to about 0.1 MPa normal stress, and a translating velocity of about 6 μm/sec. These charts show that the tangential force and a corresponding friction coefficient may be resolved to a high resolution.

### EXAMPLE 6

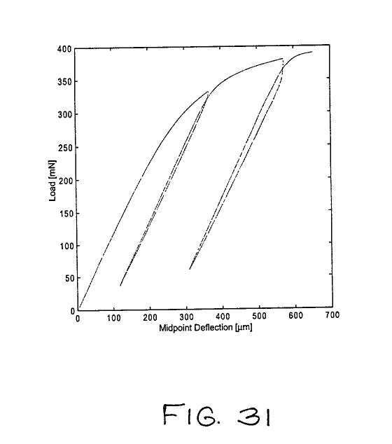

FIG. 30 shows a typical fixture or grip that may be used or installed in any of the testing apparatus described in the above examples. In particular, FIG. 30 shows a fixture capable of performing a three-point bend test on a sample. The associated load deflection graph using the fixture shown in FIG. 30 on a 0.01 inch diameter gold wire is shown in FIG. 31. The figure shows that a high resolution may be obtained to measure the load deflection properties of the sample.

Further modifications and equivalents of the invention herein disclosed will occur to persons skilled in the art using no more than routine experimentation and all such modifications and equivalents are believed to be within the spirit and scope of the invention as defined by the following claims.

What is claimed is:

1. An apparatus for characterizing a property of a sample comprising:
an actuator;
at least one displacement sensor; and
a frame supporting the actuator and the sensor, wherein a portion of the frame defines at least one flexure element.

2. The apparatus of claim 1, wherein the actuator is capable of applying a force to the sample.

3. The apparatus of claim 2, wherein a portion of the frame defines an actuating flexure element.

4. The apparatus of claim 3, wherein the actuator is connectable to the actuating flexure element.

5. The apparatus of claim 4, wherein the actuator is constructed and arranged to displace the actuating flexure element to apply the force to the sample.

6. The apparatus of claim 5, further comprising an actuating displacement sensor positioned to measure the displacement of the actuating flexure element.

7. The apparatus of claim 1, wherein a portion of the frame defines a loading flexure, the loading flexure being connectable to the sample.

8. The apparatus of claim 7, wherein the loading flexure element is displaceable, by the force applied to the sample.

9. The apparatus of claim 8, wherein a loading displacement sensor is positioned to measure the displacement of the loading flexure element.

10. The apparatus of claim 1, further comprising an actuating displacement sensor and an actuating flexure element, wherein the actuator is constructed and arranged to displace the actuating flexure element and the actuating displacement sensor is positioned to measure the displacement of the actuating flexure element and further comprising a loading displacement sensor and a loading flexure element, wherein the loading displacement sensor is positioned to measure the displacement of the loading flexure element.

11. The apparatus of claim 10, further comprising a controller capable of receiving input signals from the actuating displacement sensor and the loading displacement sensor.

12. The apparatus of claim 11, wherein the controller is capable of calculating, at least in portion, from the input signals the displacement of the sample in response to a force applied to the sample.

13. The apparatus of claim 1, wherein the apparatus characterizes the sample at the mesoscale.

14. The apparatus of claim 1, wherein the actuator is capable of creating a displacement of the sample.

15. The apparatus of claim 14, wherein the flexure element is capable of providing a force proportional to its displacement.

16. The apparatus of claim 1, wherein the apparatus is capable of applying a tensile force to the sample.

17. The apparatus of claim 15, wherein the apparatus is capable of applying a compressive force to the sample.

18. The apparatus of claim 15, wherein the apparatus is capable of applying a shear force to the sample.

19. The apparatus of claim 1, wherein the flexure element comprises a compound flexure spring.

20. The apparatus of claim 1, wherein the flexure element has substantially one axis of displacement.

21. The apparatus of claim 1, wherein the flexure element has at least one counter-rotating element.

22. The apparatus of claim 1, wherein the portion of the frame defining the flexure element comprises a platform and a set of at least two beams, each beam having a first end connected to the platform.

23. The apparatus of claim 22, wherein the beams are substantially parallel.

24. The apparatus of claim 22, wherein the beams are symmetrical.

25. The apparatus of claim 1, wherein the portion of the frame forming the flexure element defines a platform section and a spring section having a set of at least two beams associated with the platform section.

26. The apparatus of claim 1, wherein the displacement sensor is capable of measuring a displacement of the sample without contact.

27. The apparatus of claim 1, wherein the frame comprises a material from a group consisting of semiconductors, polymers and metals.

28. The apparatus of claim 27, wherein the material is silicon.

29. The apparatus of claim 1, further comprising an actuator controller capable of providing a signal to the actuator.

30. The apparatus of claim 1, further comprising a data acquisition system capable of receiving an input signal from the displacement sensor.

31. The apparatus of claim 1, further comprising a sample holder attachable to the frame and capable of supporting the sample.

32. The apparatus of claim 1, wherein the flexure element is constructed and arranged to accept the sample holder.

33. The apparatus of claim 31, wherein the sample holder is thermally insulating.

34. The apparatus of claim 31, wherein the sample holder is electrically insulating.

35. The apparatus of claim 31, wherein the sample holder is constructed and arranged to align a lengthwise axis of the sample along the axis of displacement.

36. The apparatus of claim 31, wherein the sample holder comprises at least one grip.

37. The apparatus of claim 1, wherein the frame is mountable to a surface.

38. The apparatus of claim 37, wherein the surface is capable of insulating the frame from surrounding vibrations.

39. The apparatus of claim 38, wherein the frame is mountable at orientation that is substantially perpendicular to the surface.

40. The apparatus of claim 38, wherein the frame is mountable at orientation that is substantially lateral relative to the surface.

41. The apparatus of claim 38, wherein the frame is mountable at orientation that is substantially horizontal relative to the surface.

42. The apparatus of claim 1, wherein the flexure element is capable of exerting a force between about 1 μN and about 10 N.

43. An apparatus comprising a frame having a flexure element, the frame is constructed and arranged to be mountable on a surface that is changeable by a user from a first orientation to a second orientation.

44. The apparatus of claim 43, wherein the first orientation is perpendicular and the second orientation is horizontal.

45. The apparatus of claim 43, wherein the first orientation is perpendicular and the second orientation is lateral.

46. The apparatus of claim 43, wherein the first orientation is horizontal and the second orientation is perpendicular.

47. An apparatus comprising:
a frame including at least two beams integral therewith, each beam having a first end integral with a first platform;
an actuator being supported on the frame and being capable of displacing the first platform a displacement; and
a displacement sensor being supported on the frame and capable of measuring the displacement of the first platform.

48. The apparatus of claim 47, wherein the displacement is substantially perpendicular to the length of the beams.

49. The apparatus of claim 48, wherein the force is proportional to the displacement.

50. The apparatus of claim 47, wherein the flexure element is constructed to restrict the displacement along an axis.

51. An apparatus for characterizing a sample, the apparatus capable of applying a force to the sample between about 1 μN and about 10 N with a resolution of less than about 50 μN.

52. The apparatus of claim 51, wherein the force is a tensile force applied to a sample.

53. The apparatus of claim 51, wherein the force is a compressive force applied to a sample.

54. The apparatus of claim 51, wherein the force is between about 1 μN to about 100 μN.

55. The apparatus of claim 51, wherein the force is between about 100 μN to about 10 mN.

56. The apparatus of claim 51, wherein the force is between about 10 mN to about 1 N.

57. The apparatus of claim 51, wherein the force is between about 10 μN to about 1 mN.

58. The apparatus of claim 51, wherein the resolution is less than about 25 μN.

59. The apparatus of claim 51, wherein the resolution is less than about 15 μN.

60. The apparatus of claim 51, wherein the resolution is less than about 10 μN.

61. An apparatus comprising:
a frame having a first flexure element integral with a first portion thereof and a second flexure element integral with a second portion thereof;
an actuator supported by the frame, the actuator constructed and arranged to displace the first flexure element by a first displacement;
a first displacement sensor supported by the frame and capable of measuring the first displacement; and
a second displacement sensor supported by the frame and capable of measuring a second displacement of the second flexure element.

62. The apparatus of claim 61, wherein the first flexure element has a first platform and a first set of substantially parallel beams arranged to be substantially perpendicular to a first platform lengthwise direction.

63. The apparatus of claim 62, wherein the first platform is displaceable substantially along a first axis that is substantially parallel to the first platform lengthwise direction.

64. The apparatus of claim 63, wherein a second platform is displaceable substantially along a second axis that is substantially parallel to the first axis.

65. The apparatus of claim 64, wherein the second flexure element has a second set of substantially parallel beams arranged to be substantially perpendicular to a second platform lengthwise direction.

66. The apparatus of claim 65, wherein the first platform lengthwise direction is substantially parallel to the second platform lengthwise direction.

67. The apparatus of claim 65, wherein the first platform lengthwise direction is substantially perpendicular to the second platform lengthwise direction.

68. An apparatus for characterizing a sample comprising:
a frame having a portion that defines a flexure element;
an indenter supported on the frame;
an actuator supported on the frame and constructed and arranged to displace the indenter by a displacement; and
a displacement sensor supported on the frame and capable of measuring the displacement.

69. The apparatus of claim 68, further comprising a sample stage constructed and arranged to be capable of supporting the sample without substantial displacement when the indenter contacts the sample.

70. An apparatus for characterizing a sample comprising:
a first actuator being capable of creating a first displacement along a first axis;
a second actuator being capable of creating a second displacement along a second axis;
a first displacement sensor being capable of measuring the first displacement;
a second displacement sensor being capable of measuring the second displacement; and
a frame supporting the first and second actuators and the first and second displacement sensors, wherein a first portion of the frame defines a first flexure element and a second portion of the frame defines a second flexure element and the second axis is substantially perpendicular relative to the first axis.

71. The apparatus of claim 70, further comprising a sample holder mountable to the frame.

72. The apparatus of claim 71, wherein the sample holder comprises a first grip and a second grip.

73. The apparatus of claim 72, wherein the first grip is mountable to the first flexure element and the second grip is mountable to the second flexure element.

74. The apparatus of claim 70, wherein the first flexure element is capable of generating a first force that is proportional to the first displacement.

75. The apparatus of claim 70, wherein the second flexure element is capable of generating a second force that is proportional to the second displacement.

76. The apparatus of claim 75, wherein the first force is substantially de-coupled from the first force.

77. An apparatus for characterizing a sample comprising:
an actuator;
at least one displacement sensor; and
a frame supporting the actuator and the displacement sensor, wherein the actuator is capable of displacing a first portion of the frame.

78. The apparatus of claim 77, wherein the frame is a unitary structure.

79. The apparatus of claim 77, wherein the first portion of the frame is capable of displacing the sample.

80. The apparatus of claim 77, wherein the sample is capable of displacing a second portion of the frame.

81. The apparatus of claim 77, wherein the second portion of the frame is capable of exerting a force on the sample.

82. The apparatus of claim 77, wherein a first displacement sensor is capable of measuring a displacement of the second portion of the frame.

83. The apparatus of claim 82, further comprising a second displacement sensor capable of measuring a displacement of the first portion of the frame.

84. The apparatus of claim 83, further comprising a controller that is capable of receiving input signals corresponding to the displacement of the second portion of the frame and is capable of determining the force on the sample, at least in portion, from the input signals.

85. An apparatus for characterizing a sample comprising:
an actuator;
a displacement sensor; and
a frame supporting the actuator and the displacement sensor, wherein a portion of the frame is displaceable by a force from the sample and the displacement sensor is capable of measuring the displacement of the portion of the frame.

86. The apparatus of claim 85, wherein the frame is a unitary structure.

87. The apparatus of claim 86, wherein the force is between about 1 μN to about 10 N.

88. The apparatus of claim 86, wherein the actuator is capable of displacing a second portion of the frame to create a tensile force on the sample.

89. The apparatus of claim 86, wherein the actuator is capable of displacing a second portion of the frame to create a compressive force on the sample.

90. The apparatus of claim 86, wherein the actuator is capable of displacing a second portion of the frame to create a shear force on the sample.

91. An apparatus for characterizing a sample comprising:
a frame having a first portion and a second portion, the first and second portions capable of being displaced along an axis, the first portion capable of displacing the sample substantially along the axis and the second portion capable of exerting a force on the sample substantially along the axis.

92. The apparatus of claim 91, wherein the frame is a unitary structure.

93. An apparatus for characterizing a sample comprising:
a frame having a first portion capable of displacing along a first axis and a second portion capable of displacing along a second axis, the first portion capable of applying a first force to the sample along the first axis and the second portion capable of applying a second force to the sample along the second axis.

94. The apparatus of claim 93, wherein the frame is a unitary structure.

95. The apparatus of claim 94, wherein the first axis is substantially perpendicular to the second axis.

96. The apparatus of claim 94, wherein the first axis is substantially parallel to the second axis.

97. The apparatus of claim 96, wherein the first axis is the same as the second axis.

98. An apparatus for characterizing a sample comprising:
at least one actuator;
a displacement sensor; and
a frame supporting the actuator and the displacement sensor, wherein the frame is capable of exerting a first force along a first axis and a second force along a second axis.

99. A method comprising:
displacing a first end of a sample by a first rectilinear displacement along an axis;
displacing a second end of a sample by a second rectilinear displacement along the axis; and
creating a force proportional to the second displacement along the axis.

100. The method of claim 99, further comprising the step of measuring the first displacement.

101. The method of claim 100, further comprising the step of applying a second force along a second axis that is substantially perpendicular relative to the first axis.

102. A method for characterizing a sample comprising:
providing a testing apparatus comprising:
a frame supporting an actuator;
a loading displacement sensor and an actuating displacement sensor; and
a loading flexure element integral with the frame and an actuating flexure
element integral with the frame;
determining a reactive force curve created by the loading flexure element in response to a loading displacement of the loading flexure element;
supporting a first end of the sample in the actuating flexure element and a second end of the sample in the loading flexure element;
actuating the actuator to create an actuating displacement in the actuating flexure element; and
determining the loading displacement in response to the applied force on the sample.

103. The method of claim 102, further comprising the step of determining the reactive force exerted on the sample by comparing the loading displacement to the reactive force curve.

104. A method for characterizing a sample comprising:
providing a testing apparatus comprising a frame having a sample stage and supporting an actuator and a displacement sensor, the frame defining a flexure element supporting an indenter;
supporting the sample on the sample stage;
actuating the actuator to create a displacement of the flexure element and the indenter;
measuring the displacement; and
determining the applied force to the sample by comparing the displacement to a calibration curve.

105. A method for characterizing a sample comprising:
providing a testing apparatus comprising:
a frame supporting an normal actuator;
a translating actuator;
a normal loading displacement sensor; and
a translating displacement sensor, the frame defining a normal loading flexure element and an translating flexure element;
supporting the sample in the frame;
actuating the actuator to create a normal loading displacement in the normal flexure element and apply a normal force on the sample;
actuating the translating actuator to create a translating displacement in the translating flexure element; and
measuring the normal loading displacement and the translating displacement.

106. The method of claim 105, further comprising the step of determining a normal reactive force curve created by the normal loading flexure element in response to a normal loading displacement of the normal loading flexure element.

107. The method of claim 105, further comprising the step of determining a translating reactive force curve created by the translating loading flexure element in response to a translating displacement of the translating flexure element.

108. An apparatus for characterizing a sample comprising:
an actuator;
a displacement sensor; and
a frame supporting the displacement sensor, wherein a portion of the frame is displaceable by a force from the sample and the displacement sensor is capable of measuring the displacement of the portion of frame.

109. A method for producing a testing apparatus comprising:
providing a substantially planar billet having a desired thickness;
forming a flexure element from a portion of the billet;
installing an actuator on the billet; and
installing a displacement sensor on the billet capable of measuring the displacement of the flexure element.

110. An apparatus comprising:
a flex element having at least two beams, each beam having a first end integral with a first platform;
an actuator capable of displacing the first platform a displacement; and
a displacement sensor capable of measuring the displacement of the first platform.
